(19) United States
(12) Patent Application Publication
(10) Pub. No.: US 2006/0240790 A1
(43) Pub. Date: Oct. 26, 2006

(54) Wireless transmitter

(76) Inventors: Paul Timmis, Kanata (CA); Michael Brown, Orleans (CA); Andrew Munro, Kanata (CA); Theo Pantazopoulos, Ottawa (CA); Jeffrey Lariviere, Mountain (CA); Trevor Yensen, Ottawa (CA); Niclas Lewis, Ottawa (CA)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/389,406

(22) Filed: Mar. 24, 2006

Related U.S. Application Data
(60) Provisional application No. 60/664,702, filed on Mar. 24, 2005.
(60) Provisional application No. 60/665,833, filed on Mar. 29, 2005.
(60) Provisional application No. 60/738,098, filed on Nov. 21, 2005.

(51) Int. Cl. H04B 1/04; H01Q 11/12

(52) U.S. Cl. 455/127.4; 455/127.1

(57) ABSTRACT

A wireless transmitter for generating and transmitting wireless signals comprises a main unit and a plurality of auxiliary units, each having an outer casing and a fastening mechanism for connecting the casing of each auxiliary unit to that of the main unit. The main unit includes a signal generator for generating a plurality of carrier signals simultaneously and an interface for transmitting a carrier signal to each of the auxiliary units when connected thereto. Each auxiliary unit comprises a power amplifier and an optional upconverter, and a connector for connecting an antenna thereto. The signal generator of the main unit is configurable to generate different predetermined waveforms which are received through a communication interface. The transmitter unit is portable and a coupling mechanism is provided to lock the transmitter onto a backpack support.

### CROSS REFERENCE TO RELATED APPLICATIONS

This application claims priority from U.S. Provisional Patent Application No. 60/664,702 filed on 24 Mar., 2005, U.S. Provisional Patent Application No. 60/665,833 filed on 29 Mar., 2005 and U.S. Provisional Patent Application No. 60/738,098 filed on 21 Nov., 2005, the entire contents of which is incorporated herein by reference.

### FIELD OF THE INVENTION

The present invention relates to wireless transmitters, and in particular but not limited to wireless transmitters for generating jamming signals.

### BACKGROUND OF THE INVENTION

Radio signal jamming devices typically generate a radio frequency signal of a selected frequency which prevents proper reception of other RF signals within that frequency band to disrupt or prevent RF communication. RF jamming devices generally comprise a radio transmitter having a signal generating section, an amplifier section and an RF antenna, and the signal generating section can be tuned to a selected jamming frequency.

### SUMMARY OF THE INVENTION

According to one aspect of the present invention, there is provided a transmitter for transmitting wireless signals comprising a main unit and a plurality of auxiliary units, means for releasably connecting each auxiliary unit to the main unit, the main unit comprising signal generating means for generating a plurality of carrier signals simultaneously and means for delivering a carrier signal to each of said auxiliary units when connected thereto.

In some embodiments, one or more auxiliary units may each comprise signal conditioning means for conditioning the carrier signal received from the main unit. The signal conditioning means may include any one or more of an upconverter and a power amplifier. Each auxiliary unit may further comprise a connector for connecting an antenna thereto.

Each auxiliary unit may be specifically adapted for operating with a particular frequency or frequency band and the frequency or frequency bands may differ between different auxiliary units. This arrangement enables each auxiliary unit to be optimized for a particular frequency or frequency band to provide a power efficient transmitter system capable of covering different frequency bands simultaneously.

According to another aspect of the present invention, there is provided a radio transmitter comprising a first unit having signal generating means for generating one or more carrier signals and a second unit for receiving a carrier signal from the first unit and releasably mountable to the first unit and comprising a converter for changing the frequency of the carrier signal received from the first unit.

According to another aspect of the preset invention, there is provided a radio transmitter comprising a first unit, a second unit and a third unit, said first unit comprising signal generating means for generating a signal, said second unit being releasably couplable to at least one of said first and third units and having means for receiving the signal generated by said signal generating means and said third unit being releasably couplable to at least one of said first and second units and having means for receiving a signal from at least one of said signal generating means and from said second unit.

According to another aspect of the present invention, there is provided a radio transmitter comprising a first unit and a second unit, wherein said first unit comprises signal generating means and said second unit is adapted to receive a signal from said signal generating means and is releasably connectable to said first unit.

According to another aspect of the present invention, there is provided a radio transmitter comprising a first unit and a second unit, the first unit comprising signal generating means and the second unit comprising means for receiving the signal generated by the signal generating means and which is releasably couplable to the first unit, and wherein the signal generating means is capable of generating successive signals each having a different frequency.

According to another aspect of the present invention, there is provided a radio transmitter comprising means for generating a plurality of carrier signals simultaneously, and means for modulating at least one of said carrier signals with another signal or signals.

According to another aspect of the present invention, there is provided a module for a radio transmitter, comprising a port for receiving a signal to be transmitted and an amplifier for amplifying the signal, and means for coupling said signal to an antenna for wireless transmission.

According to another aspect of the present invention, there is provided a portable wireless transmitter capable of generating a plurality of carrier frequencies simultaneously and having an interface for enabling one or more functions of said transmitter to be configured.

According to another aspect of the present invention, there is provided an apparatus for displaying information about a radio transmitter, the transmitter being capable of generating and transmitting a plurality of wireless carrier frequency signals simultaneously, said apparatus comprising an interface for transmitting and/or receiving information to/from said transmitter, and a processor adapted for generating a visual representation of said information, and a graphical user interface for displaying said representation.

According to another aspect of the present invention, there is provided a radio transmitter comprising: a signal generator for generating simultaneously a plurality of signals; and a plurality of amplifiers each arranged to receive and amplify a respective one of said signals for wireless transmission.

In this arrangement, the radio transmitter has a plurality of channels on which signals can be transmitted simultaneously. Advantageously, this allows the radio transmitter to transmit jamming signals having different frequencies at the same time. The radio transmitter further includes an amplifier for each channel which enables the power of each channel to be set independently of the other channel(s).

In some embodiments, the radio transmitter may further comprise a plurality of antennae, one for each channel. Providing a separate antenna for each channel allows the antenna to be specifically selected for operation with the specific characteristics of the channel, such as channel frequency (and bandwidth). Thus, rather than driving all channels through a single broadband antenna, which may be relatively inefficient, each antenna can be selected to the particular frequency or frequency band of a specific channel for increased effective radiated power. A set of different antennae may be provided for use with the radio transmitter so that one antenna can be substituted for another depending on the selected channel frequency. For example, more antennae can be provided than the number of simultaneously available channels so that when the frequency of one or more channels is changed, the antenna (e) can be changed to match the new frequency. Thus, in some embodiments, the efficiency as a function of frequency of at least one antenna is different from that of at least one other antenna.

In some embodiments, one or more amplifier(s) comprises a broadband amplifier. Advantageously, the use of a broadband amplifier allows the channel frequency to be varied over a wide range. In one embodiment, the frequency range of one or more power amplifiers is about 20 MHz to 520 MHz. In other embodiments one or more amplifier(s) may operate over any other frequency range.

In some embodiments, the signal generator is adapted for generating simultaneously three or more signals, and in a specific embodiment, the signal generator is capable of generating four (or more) channels simultaneously.

In some embodiments, the radio transmitter further comprises a waveform generator for generating a waveform and modulating a carrier signal with the waveform. One or more waveforms may be stored in the radio transmitter, for example in an electronic memory, and a waveform may be selected by means of a user interface. The radio transmitter may include a data port for receiving user input commands and data which may include one or more predetermined waveforms or waveform selection(s).

The radio transmitter may be adapted for mounting in a vehicle, and may be adapted to receive power from the vehicle electrical power supply. The radio transmitter may include a power conditioner for conditioning the power supplied from the vehicle, for example, to protect from transient surges and spikes from the vehicle's power system.

Also according to the present invention, there is provided a wireless transmitter comprising: a signal generator for generating simultaneously a plurality of carrier signals each defining a channel; amplifier means for amplifying the signal of each channel; a plurality of ports, a respective port being associated with a respective channel and for outputting a respective amplified signal to a respective antenna for wireless transmission.

Advantageously, in this arrangement, the wireless transmitter comprises a plurality of ports each for a respective different channel so that the signal for each channel can be wirelessly transmitted from a separate antenna. This allows the antenna for each channel to be specifically matched to the channel frequency or frequency band. In some embodiments, a plurality of channels may be amplified by the same amplifier and one or more filters may be provided to separate each channel so that the separate channels are passed to a respective antenna. In other embodiments, the amplifier means comprises a plurality of amplifiers, one for each channel. Advantageously, this arrangement assists in enabling parameters of each channel to be controlled independently of that or those of another channel.

In some embodiments, the signal of one or more channel comprises a deterministic signal. A deterministic signal is generally a signal which is a non-communication signal, i.e. a signal which does not carry meaningful information for the purposes of communication. In some embodiments, the signal comprises a jamming signal, i.e. a signal which is intended to interfere or disrupt communication signals. The signal may comprise a simple carrier frequency or a carrier frequency which is modulated with one or more other frequencies which may be defined by a predetermined waveform. The frequency or frequencies which are to form the predetermined waveform may be selected and/or generated by an operator.

In some embodiments, the radio transmitter further comprises signal modulator means for modulating one or more carrier signals, and means for varying the carrier frequency of one or more of said modulated signals. The radio transmitter may further comprise a controller for changing the carrier frequency and the controller may be programmed or otherwise conditioned or arranged to vary the carrier frequency over time according to a predetermined function. For example, the controller may be configured to sweep a carrier frequency over a range of different frequencies or to control the carrier frequency to acquire a number of different values over time.

In some embodiments, the signal generating means may be adapted to modulate a carrier signal with a plurality of different frequencies. The plurality of frequencies may extend over a predetermined frequency band and may comprise a comb of frequencies.

In some embodiments, the signal generating means is capable of generating successive signals each having a different frequency.

In some embodiments, the radio transmitter is dimensioned to be portable by a human operator.

In some embodiments, the wireless transmitter comprises a plurality of amplifiers, each comprising a communication interface, and the wireless transmitter comprises a communication module for communicating with the communication interface of each amplifier.

In some embodiments, the wireless transmitter comprises connector associated with each port for outputting a carrier signal, for releasably connecting an antenna to a respective port.

In some embodiments, the efficiency of at least one antenna varies as a function of frequency, and wherein the antenna is efficient at the frequency of the signal to be wirelessly transmitted by the antenna.

In some embodiments, the amplifier means comprises an amplifier capable of amplifying signals over a predetermined range of frequencies, and one or more antenna is efficient over a restrictive range of frequencies within the predetermined range.

In some embodiments, the wireless transmitter further comprises a communication module for receiving external communication signals, and for controlling the configuration of the radio transmitter in response to the external communication signals.

According to another aspect of the present invention, there is provided a coupling comprising first and second coupling elements; the first coupling element comprising a first part defining opposed first and second outer walls, and a second part extending outwardly from said first wall and having a distal end, and a length between said second wall and said distal end; and said second coupling element comprising a receptacle for receiving said second part, said receptacle being defined between opposed first and second surfaces which are spaced apart by a distance for accommodating the length of said second part, and latch means disposed between the opposed first and second surfaces of said receptacle and an aperture between said latch means and the first surface of said receptacle for permitting the second part of the first coupling element to pass therethrough into the receptacle and engage with said latching means on relative rotation between said first and second coupling elements.

In some embodiments, the second part has a surface for abutting the latching means and a surface generally opposite the latching surface for engaging a surface of the receptacle to prevent relative linear movement of the coupling elements when the second part is engaged with the latch means.

In some embodiments, the length of the second part is substantially equal to the distance between the first and second surfaces of said receptacle.

In some embodiments, the coupling element further comprises means defining an abutment surface for engaging the first wall of the first part of said first coupling element when said second part engages said latch means.

In some embodiments, one of said first and second coupling elements is provided on a support bracket and the other of said first and second coupling elements is provided on a unit to be supported by said support bracket.

In some embodiments, the support bracket comprises mounting means for mounting the bracket to the support frame for a backpack.

In some embodiments, the first coupling element is provided on said bracket.

In some embodiments, the unit comprises a casing.

In some embodiments, the unit comprises a housing for a portable electronic system.

In some embodiments, the electronic system includes a radio transmission system.

In some embodiments, at least a portion of the surface of said second part which is disposed generally opposite the latch engaging surface is curved.

In some embodiments, the surface is curved in a region adjacent at least one of the distal end of said first part and a proximal end thereof adjacent said first part.

According to another aspect of the present invention, there is provided an apparatus comprising first and second interconnectable parts, the first part having means for pivotally mounting the second part thereto to allow the second part to be swung away from and towards said first part about said pivotal mounting means, limiting means for limiting pivotal movement of the second part away from the first part and for maintaining the second part in a predetermined positioned on said pivotal mounting when the second part is swung away from the first part, the pivotal mounting means and the limiting means being arranged to allow the second part to be released therefrom.

In some embodiments, the limiting means is arranged to reversibly latch and release said second part on movement of said second part past said limiting position.

In some embodiments, the pivotal mounting means comprises a supporting surface for supporting the weight of said second part and said second part comprises a bearing surface for resting on the support surface of said first part.

In some embodiments, the second part can be disengaged from said pivotal support surface by lifting said second part relative to said first part.

In some embodiments, the limiting means comprises latching means for releasably latching said first part to said second part.

In some embodiments, the latching means comprises a first member mounted on said first part and a second member mounted on said second part, said first and second members being positioned to inter engage one another when said second part is swung towards said first part about said pivotal mounting means.

In some embodiments, at least one of said first and second members is capable of deflecting away from the other member to disengage said other member therefrom.

In some embodiments, at least one of said first and second members comprises a resilient material or structure to provide said deflection.

In some embodiments, the first part comprises a casing having a wall, and said pivot means comprises a portion of said wall.

In some embodiments, one of said latching members comprises an elongate member having opposed ends, one end being mounted on one of said first and second parts and a free end extending from said part and capable of moving in a direction transversely of its length, and having a detent for latching to the latching member of the other part.

In some embodiments, the elongate member comprises a leaf spring.

In some embodiments, the other member comprises a pin for engaging said detent.

In some embodiments, at least one of said first and second parts comprise a casing housing an electrical system.

In some embodiments, one of said parts houses signal generating means.

In some embodiments, at least one of said first and second parts comprises a radio signal transmitter.

In some embodiments, the first part comprises a signal generator and said second part comprises a power amplifier and radio transmitter.

In some embodiments, the first and second parts are components of a radio jamming system.

According to another aspect of the present invention, there is provided an apparatus connectable to a radio transmitter for enabling an operator to form a desired waveform and for programming said transmitter to generate said waveform.

According to another aspect of the present invention, there is provided an auxiliary module connectable to a main unit of an RF transmitter, wherein the auxiliary module comprises any one or more features or components.

According to another aspect of the present invention, there is provided a main unit of an RF transmitter comprising any one or more features or components disclosed herein.

According to another aspect of the invention, there is provided a wireless transmitter for generating and transmitting wireless signals comprises a main unit and a plurality of auxiliary units, each having an outer casing and a fastening mechanism for connecting the casing of each auxiliary unit to that of the main unit. The main unit includes a signal generator for generating a plurality of carrier signals simultaneously and an interface for transmitting a carrier signal to each of the auxiliary units when connected thereto. Each auxiliary unit comprises a power amplifier and an optional upconverter, and a connector for connecting an antenna thereto. The signal generator of the main unit is configurable to generate different predetermined waveforms which are received through a communication interface. The transmitter unit is portable and a coupling mechanism is provided to lock the transmitter onto a backpack support.

### BRIEF DESCRIPTION OF THE SEVERAL VIEWS OF THE DRAWINGS

Examples of embodiments of the present invention will now be described with reference to the drawings, in which:

FIG. 1 shows a front view of a transmitter unit according to an embodiment of the present invention;

FIG. 2 shows a rear view of the transmitter shown in FIG. 1;

FIGS. 3 and 4 show side views of the transmitter shown in FIG. 1;

FIG. 5 shows a top view of the transmitter shown in FIG. 1;

FIG. 6 shows a bottom view of the transmitter shown in FIG. 1;

FIG. 7 shows a schematic diagram of a transmitter according to an embodiment of the present invention;

FIG. 8 shows a block diagram of a transmitter circuit according to an embodiment of the present invention;

FIGS. 9A to 9D show a mounting system for mounting a battery to the transmitter unit;

FIGS. 10A to 10E show a mounting system for mounting a transmitter module to a transmitter unit, according to an embodiment of the present invention;

FIGS. 11A to 11C show a unit mounting system according to an embodiment of the present invention;

FIGS. 12A and 12B show a mounting system for the transmitter unit;

FIGS. 13 to 17 show examples of a graphical user interface for programming and controlling the transmitter unit according to embodiments of the present invention;

FIG. 18 shows an external perspective view of a radio transmitter according to an embodiment of the present invention;

FIG. 19 shows a schematic diagram of a radio transmitter according to an embodiment of the present invention;

FIG. 20 shows a schematic diagram of a signal generator;

FIG. 21 shows a block diagram of a generator sub-core according to an embodiment of the present invention;

FIG. 22 shows an exploded perspective view of a radio transmitter according to an embodiment of the present invention;

FIG. 23 shows a perspective view of a radio transmitter with the top of the housing removed to show the layout of components thereof;

FIG. 24 shows an external perspective view of a signal generator;

FIG. 25 shows an example of a mounting system for mounting the radio transmitter in a vehicle;

FIG. 26 shows a block diagram of a radio transmitter according to an embodiment of the present invention; and

FIG. 27 shows a schematic diagram of a radio transmitter with a set of antennae for use therewith.

### DETAILED DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

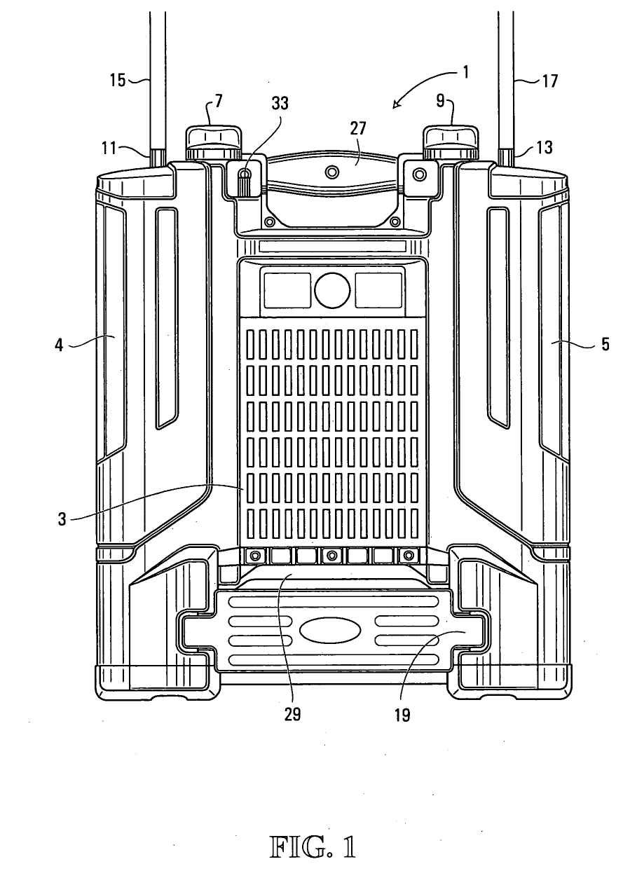

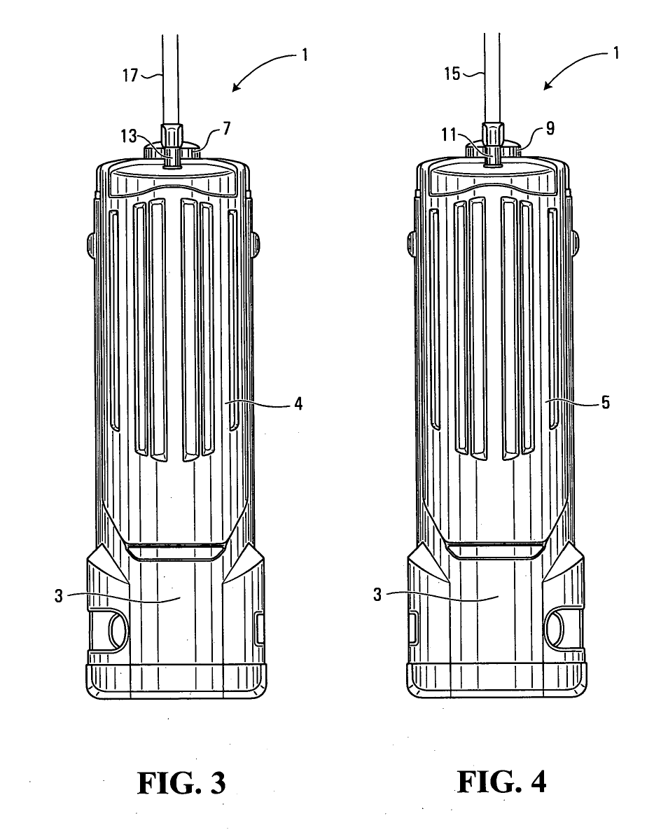

Referring to FIGS. 1 to 6, a transmitter unit generally shown at 1 according to an embodiment of the present invention comprises a main unit 3 and first and second RF (radio frequency) transmission modules 4, 5 each of which is releasably connected to the main unit by, for example a locking system 7, 9. Each module has one or more antenna mountings 11, 13 for mounting one or more antennas 15, 17 therefrom. The transmitter 1 further comprises a battery housing 19 for storing a battery 21 for providing electrical power to the unit. A latching mechanism 23, 25 is provided to releasably secure the battery 21 in the housing 19 and which will be described in more detail below.

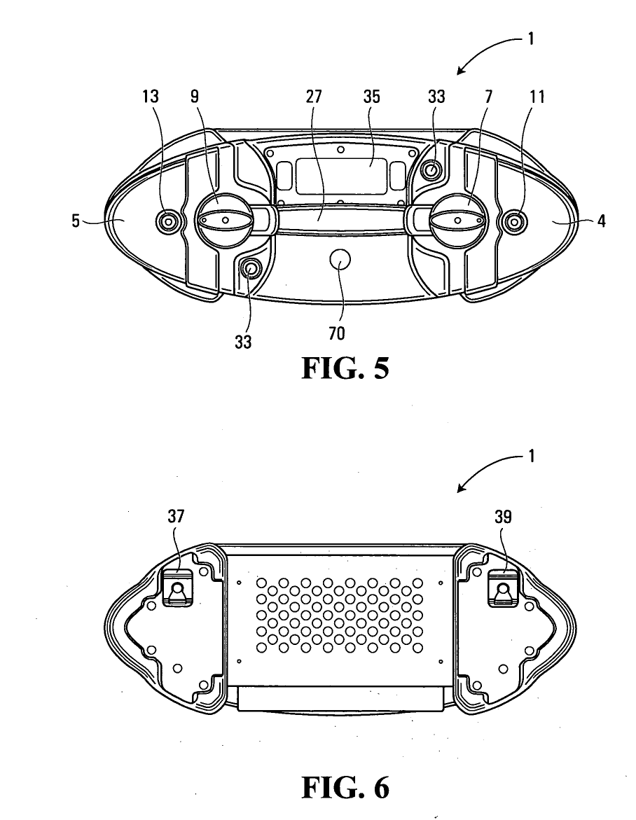

The unit may optionally comprise a carrying handle 27 to allow the unit to be carried by hand. The unit may provide a recess or slot 29 to allow the unit to be carried by some mechanical means such as a robot. In this example, the slot is positioned above the battery housing 19, and in other embodiments it may be positioned elsewhere. An apertured plate or grill may be provided on at least one of the front and rear faces of the main unit to protect the main unit while allowing air to circulate for cooling. One or more control switches 33 may be provided to allow operations of the unit to be controlled manually, for example. As shown in FIG. 5, a visual display 35 may be provided for displaying various functions of the unit. The displayed functions may include any one or more of the particular modes of operation, status of the unit and/or components thereof, component fault of failure indications and/or associated alarms and battery power level.

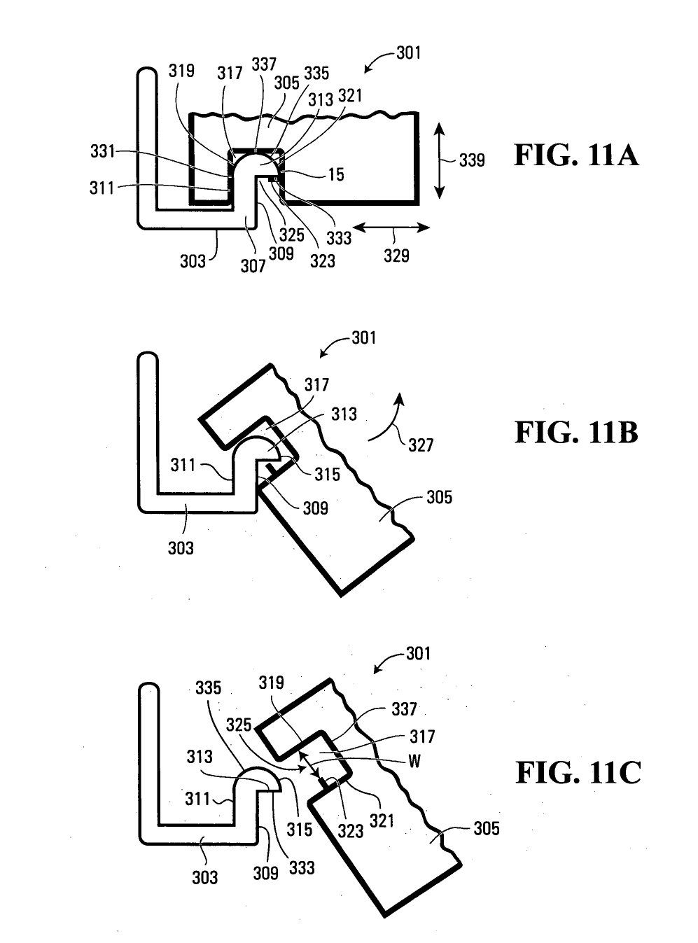

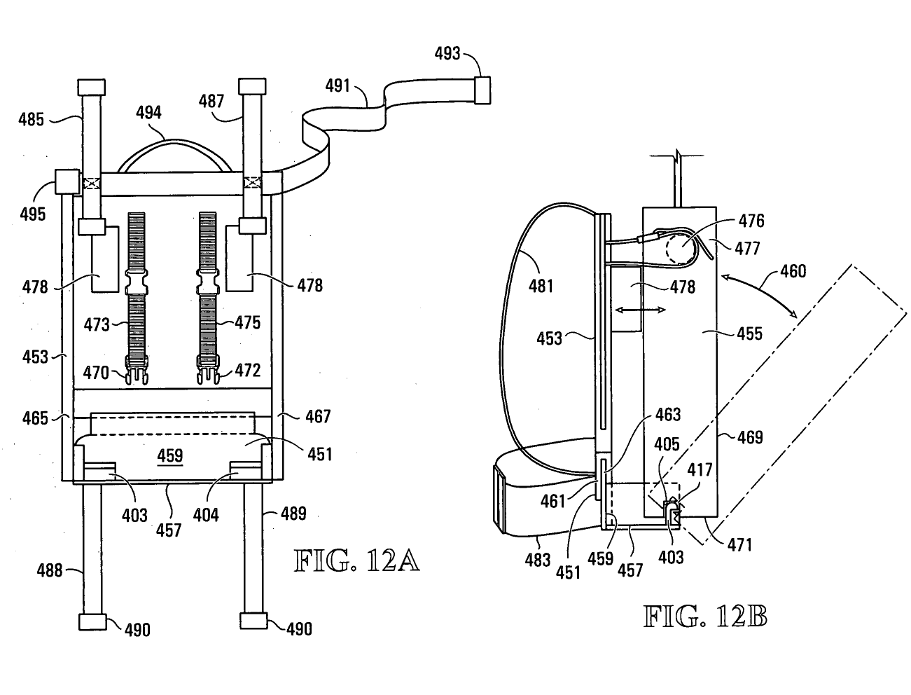

Referring to FIG. 6, the base of the unit comprises one or more mounting and/or latching mechanisms to facilitate mounting the unit to a support system for example, such as a portable carriage frame (e.g. backpack frame), to a vehicle mounted support system or to a static support system. An embodiment of a latching mechanism is described below with reference to FIGS. 11A to 11C and 12A and 12B.

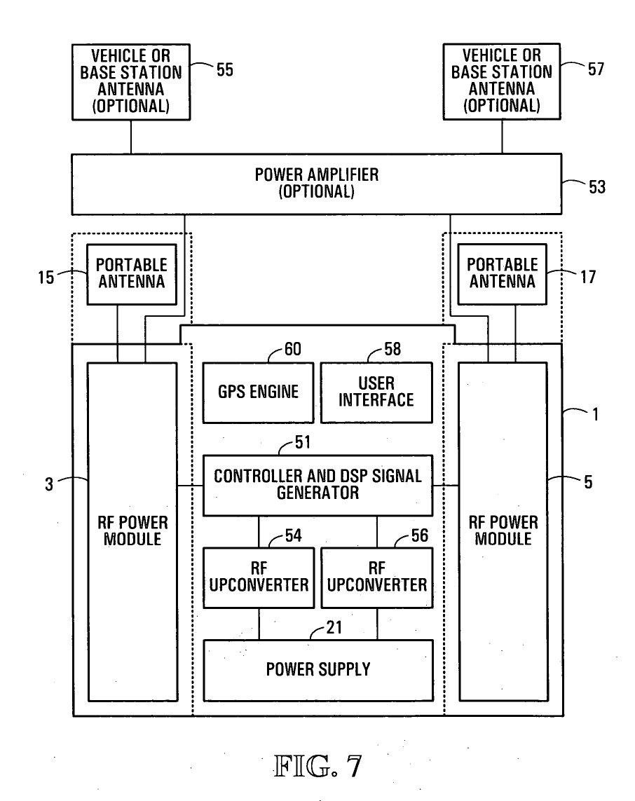

A functional block diagram of an embodiment of the transmitter unit is shown in FIG. 7. Referring to FIG. 7, the unit 1 comprises a dual (or multiple) channel signal generator 51 for driving each external RF power module 4, 5. In dismounted or hand carried operations, a portable antenna 15, 17 can be directly connected to each RF power module 4, 5. In other modes of operation, such as for high power vehicle mounted applications, the unit can be integrated with a separate, external high power amplifier driving one or more vehicle mounted antennae 55, 57, or base station antennae for non-mobile (i.e. static) applications.

The main unit 3 comprises a controller and DSP (Digital Signal Processor) signal generator 51, an RF upconverter 54, 56 for each channel, a user interface 58 for controlling and programming functions of the main unit 3 and an optional GPS (Global Positioning System) engine or device 60 for receiving GPS or reference signals to co-ordinate operations of the unit with other units, for example.

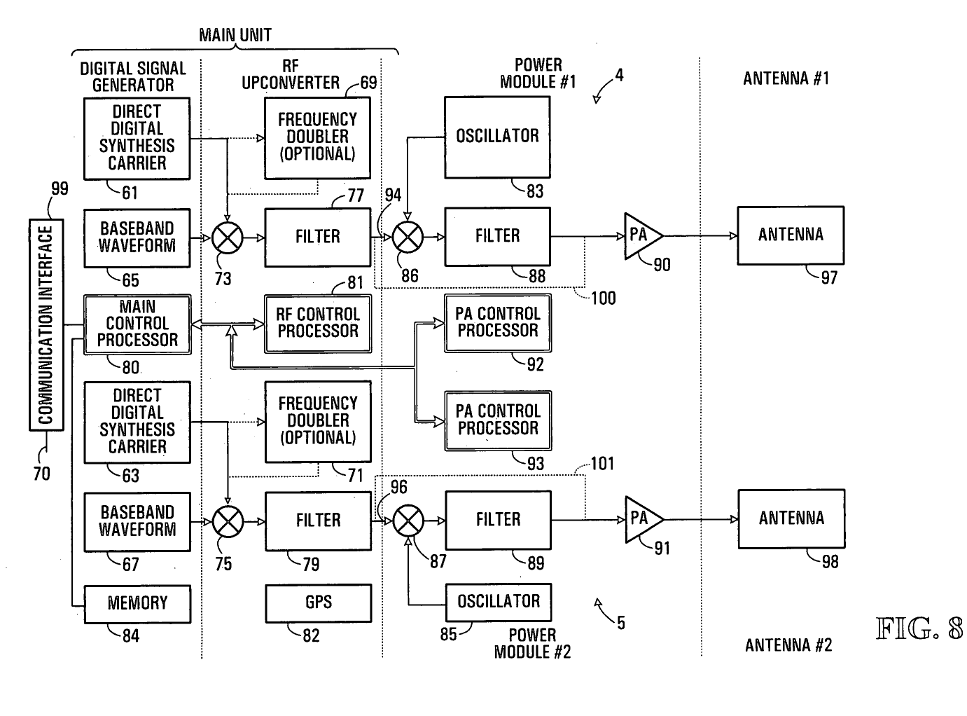

As described above, the unit further comprises a portable power supply, which may for example comprise a battery 21. However, the main unit may be adapted to receive power from other sources, depending on the mode of operation and power supply availability. For example, in vehicle mounted, possibly high power applications, the unit may be connected to receive power from a vehicle mounted power source. Referring to FIG. 8, for each RF power module, the main unit comprises a carrier generator 61, 63, for example a direct digital synthesis carrier generator, an optional frequency multiplier 69, 71, e.g. a frequency doubler, and a filter 77, 79. The main unit further comprises a main control processor 80 and an RF control processor 81. As indicated above, the main unit may further comprise a reference signal receiver 82. A memory 84 is provided for storing data such as configuration data control data, and other information required by the system.

Each power module 4, 5 comprises an optional local oscillator (e.g. frequency synthesizer) 83, 85, an optional mixer 86, 87, an optional filter 88, 89 and a power amplifier 90, 91. Each power module may further comprise an optional control processor 92, 93 for controlling functions of the power module and communicating with the main control processor 80 and/or the RF control processor 81 of the main unit.

In operation, the Digital Signal Generator generates a waveform which is processed by an RF processor module 68 (e.g. rf card) and passed to an RF Power Module. The RF Power Module (optionally) performs further up-conversion on the signal with an on-board synthesized local oscillator and mixer and amplifies the resulting signal with a high power amplifier. The signal then drives an antenna which radiates the signal.

Each carrier generator is operable to generate a carrier signal having a desired frequency and which is optionally passed to a frequency doubler 69, 71 to modify, i.e. increase the carrier frequency before it is passed to the mixer 73, 75. The carrier frequency signal may optionally be modulated by a signal generated by the base band waveform generator 65, 67, and the signal from the mixer 73, 75 is passed through a filter 77, 79 for removing unwanted frequencies optionally generated by the mixer 73, 75 before the signal is output to the power module 4, 5. In one configuration or mode of operation, the carrier frequency signal 94, 96 generated by the main unit is passed to the mixer 86, 87 of the power module for optional upconversion by mixing with a signal generated by the local oscillator 83, 85. The signal is then passed from the mixer 86, 87 to the filter 88, 89 to remove unwanted frequencies, and the filtered signal is passed to the input of the power amplifier 90, 91 where it is amplified and then passed to an antenna 97, 98 for wireless transmission. In another configuration or mode of operation, the local oscillator and mixer of one or more power modules 4, 5 may be inactive to upconvert (or modulate) the carrier signal from the main unit and the signal passed to the power amplifier either through the mixer with the local oscillator turned off, or passed directly to the power amplifier via another signal path 100, 101.

The main unit is capable of generating carrier signals (i.e. rf channels) of different frequencies simultaneously. Advantageously, the main unit may provide a base band waveform generator and mixer for modulating the carrier frequency to provide a band of carrier frequencies for simultaneous wireless transmission. In one implementation, the modulated carrier signal may be swept, for example between first and second frequencies, and at any desired repetition rate (or swept only once). Advantageously, modulating the carrier frequency, whether swept or not, allows a number of different frequencies to be generated and transmitted simultaneously, which may significantly broaden the frequency of a jamming signal in an efficient manner.

Additionally sweeping the modulated carrier signal over a range of frequencies can further increase the range jamming frequency signals that can be transmitted by the device in a short period of time.

In any of the embodiments, the carrier frequency(ies) transmitted by one module may be different to at least one, some or all carrier frequencies transmitted by the other module, which significantly increases the versatility of the transmitter.

In some modes, both modules may transmit one or more frequencies that is/are the same frequency(ies). This enables the power of the transmitted rf signal for a particular frequency or frequencies to be increased beyond the maximum power provided by a single module.

Advantageously, since the power modules are detachable from the main unit, the main unit can be used for a range of different power modules, each capable of generating frequencies within a specific range. As the power amplifier for each power module is required to amplify signals over a specific frequency range, the power amplifier can be specifically matched to the required operating range obviating the need for using a relatively inefficient broadband amplifier and enabling an efficient amplifier to be used for each power module. Advantageously, each power module can include an upconverter specifically matched to the frequency range of the power amplifier, and vice versa.

Providing the upconverter on the power module, rather than on the main unit prevents the system from being limited to generating frequencies within a narrow frequency band and/or allows an efficient power amplifier to be used with the system. The use of efficient power amplifiers can significantly reduce the power consumption of the unit, increase battery life and thereby allow the unit to run for longer periods of time before the battery needs to be replaced. Another important advantage is that the use of efficient amplifier(s) allows the amplifier to remain cool during operation, possibly removing the need for a cooling fan or reducing power required to operate a fan. Any available convective cooling should be sufficient to provide the required cooling, if any. This makes the transmitter more reliable (as fans can fail), and reduces the power drawn by the unit.

As the main unit is arranged to generate a plurality of carrier channels, some hardware of the main unit can be shared between the power modules, reducing the weight of the system making it lighter to carry and also potentially reducing the power consumed by the unit with the common advantages identified above.

Different components of the main unit, such as the main control processor 80 and the rf control processor 81 (or other components), may communicate with one another to pass information therebetween to co-ordinate proper operation of the unit. Advantageously, this obviates the need for operator intervention at this level. Alternatively, or in addition, one or more power modules may include means for communicating with the main unit to pass information required to co-ordinate operation of the power module with operation of the main unit and vice versa, and this may implemented by the optional control processor 92, 93. Again, this obviates the need for operator intervention at this level. Information that may be passed between the different components of the system may, for example, include any one or more of the type of power module, the frequency range, one or more characteristics of the power amplifier, one or more characteristics of the local oscillator or frequency synthesizer, whether or not a power module is present and properly connected, a signal indicating a fault or failure of a component for diagnostics and any other information that may be useful in co-ordinating operation of the system, or any other information about any one or more components of the main unit and/or power module(s).

Embodiments of the system may be designed to jam specific rf signals. For example, embodiments of the system may be configured to jam adverse communication signals to prevent such signals from being intelligibly received by an intended receiving device, such as a device which is to be controlled by the signal, to render the device inoperative or to change the way it operates. In one example, embodiments may be used to counter various threats such as explosive devices, e.g. improvised explosive devices (IEDs) or other devices, which may be triggered by radio signals. Embodiments of the transmitter can be deployed in any of the following scenarios:

(a) Dedicated Installation, including for example: Event Protection, Vehicle mount EOD (Explosive Ordnance Device) Operations, Vehicle Protection; (b) Ad-hoc Installation, such as: Compound (Forward Operating Base) Protection, Convoy Protection, Pole Mounted Installation;

(c) Dismounted, such as: Backpack worn during Patrol Operations, and Carried Forward.

Non-limiting examples of various components of an embodiment of the transmitter are described in more detail below.

Controller and DSP Signal Generator

The DSP Signal Generator is one of the main components of the system and, in one embodiment, contains a dual channel signal generator and controller, which may be implemented by a combination of digital circuit components, such as Digital Signal Processor(s), Field Programmable Gate Array(s), Direct Digital Synthesis Processor(s), and Digital to Analog Converter(s).

In one example, the signal generator may be capable of (digitally) generating carriers up to 700 MHz or more, e.g. from 20 MHz to 700 MHz. The carriers can be digitally modulated with arbitrary phase and/or frequency modulation. In parallel, a dual channel complex base-band signal can be generated that can be modulated onto the digital carrier by the RF Up-converter.

An external PC (Personal Computer) running a proprietary Graphical User Interface (GUI) can be used to define a waveform for transmission and to generate one or more configuration files defining characteristics of the waveform required by the system. These can be downloaded into an on-board non-volatile memory, for example memory 84 in FIG. 8.

The main controller 80 communicates with the RF Up-converter and power module processors to configure them to generate the desired waveform. The controller 80 may be adapted to determine whether the RF Power module is compatible with the desired waveform, and to provide an indication of the determination to a user, for example through a GUI connected to the transmitter unit or an on-board GUI or display.

The system configuration may be queried to ensure that the installed hardware is capable of generating the waveform. If necessary the waveform definition file can be erased from the non-volatile memory when the system is powered down by holding the on-off switch for an extended or predetermined period of time.

Some embodiments of the unit are capable of being configured to interoperate with other systems by preventing unwanted transmissions outside the intended suppression bands. The timing with which the waveforms are generated can be precisely synchronized with the required (e.g. sub microsecond) accuracy to a reference signal derived from the reference signal receiver 82, e.g. GPS.

In some embodiments, the main controller controls all interface elements of the system and performs continuous built-in-test and configuration of each sub system. The main controller 80 may also be adapted to monitor operation of one or more components or parts of the system, and to provide an indication to a user of a detected malfunction or fault. For example, if the system enters a state where its operation is compromised then the user is alerted by means of an alarm, for example through an escalating series of audio and/or visual alarms. The status of the system may be reported by the main processor on a visual display.

In some embodiments, the function of hardware not directly associated with the signal generating function (e.g. any one or more of on-off switch, visual display, piezo buzzer, tri-color LED, GPS engine) can be customized by downloading custom embedded firmware into the unit. For example, a user may wish to disable the LED and piezo warning system in specific operational roles or may require customized information to be displayed on the visual display.

RF Processor

In some embodiments, the RF control processor 81 is a dual channel system which conditions the digital carrier and base-band signals generated by the digital signal processor. It may extend the frequency generation capability of the main unit to a predetermined frequency, e.g. 700 MHz or more, and can directly modulate the digital carrier with the appropriate base-band signal to generate an intermediate or final waveform.

Some embodiments include a switch, e.g. switching matrix, for switchably coupling the channels to either one of the rf power modules, which enables the signals to be routed to either module.

In some embodiments, the RF processor 81 also includes a synthesizer which generates a clock signal of a predetermined frequency (e.g. 1 GHz) that is used to clock the Direct Digital Synthesis engines on the DSP Signal Generator.

In some embodiments, a reference signal, e.g. GPS receiver module is provided, which communicates with the central controller through a suitable interface, for example an optically decoupled serial interface, or other interface.

RF Power Module

In some embodiments, the main controller 80 is adapted to communicate with each attached RF power module to establish its capabilities and to configure the system for operation at a required frequency in a desired frequency range. The intermediate waveforms from the RF up-converter module 68 in the main unit 3 are routed to each module which may provide any one or more of the following functions:

a) Translate the intermediate signals (20 MHz to 700 MHz or more) to the final frequency band (e.g 20 MHz to 6 GHz or more).

b) Amplify the signal for either (1) Portable operation with a directly mounted antenna to the required output power level, (2) To drive an external power amplifier for high powered vehicle installed operations.

Embodiments of the transmitter system may comprise any number of different RF Power Modules each covering a different frequency range.

The amplifiers may use a wideband Class E design which provides mission optimized power amplifiers that operate with exceptional efficiency (close to 70%). This can extend battery life and allows the unit to be convection cooled, which is useful for a portable, e.g. backpack hosted system.

Embodiments of the RF power module provide temperature and/or VSWR (Voltage Standing Wave Ratio) protection circuitry to help ensure that the system remains operational under extreme physical conditions. The rf power module may be adapted to report its status to the main unit which initiates an alarm if a problem arises.

Power Supply

Embodiments of the power supply may be adapted to condition and regulate the input power source to supply power to the transmitter circuitry, and may permit a plurality of power sources to be connected to the transmitter either separately or simultaneously.
In one embodiment, one power source comprises a battery installed in the transmitter unit. The battery may store sufficient electrical energy to power the unit for more than two hours, for example 3.5 hours or more, when running with full operational capabilities.
The transmitter unit may include a connector for connecting the unit to an external power supply (e.g. vehicle or infrastructure based).

The unit may include a power source controller which, in the event that either power source is disconnected or fails causes the other power supply source to take over the supply.

The power supply may include surge suppression and/or other line protection features and can be fully inserted into the unit which may provide a heat sink required by switching power supply modules and protection components.

Battery Housing

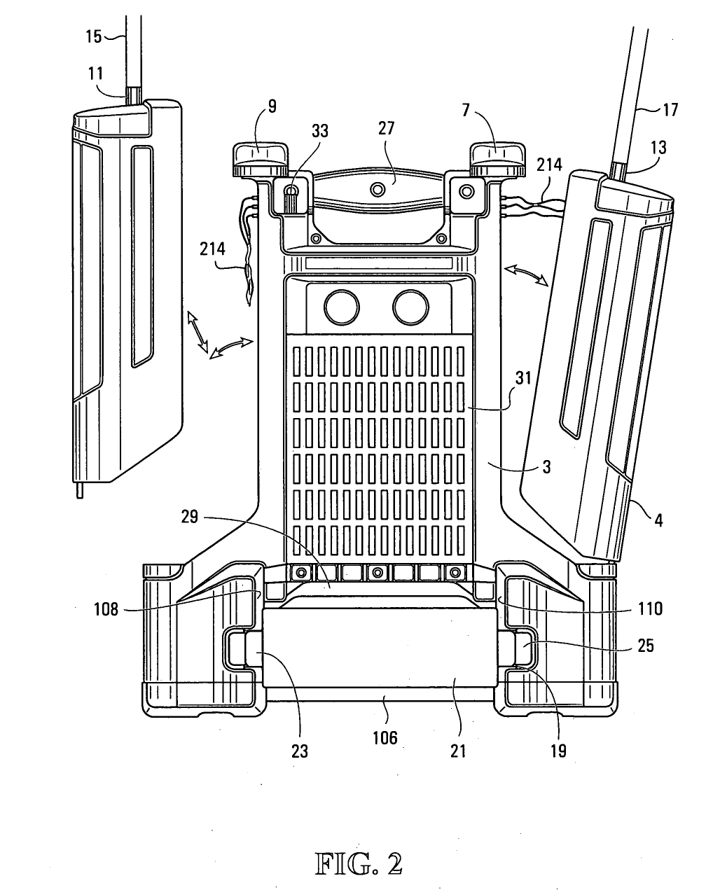

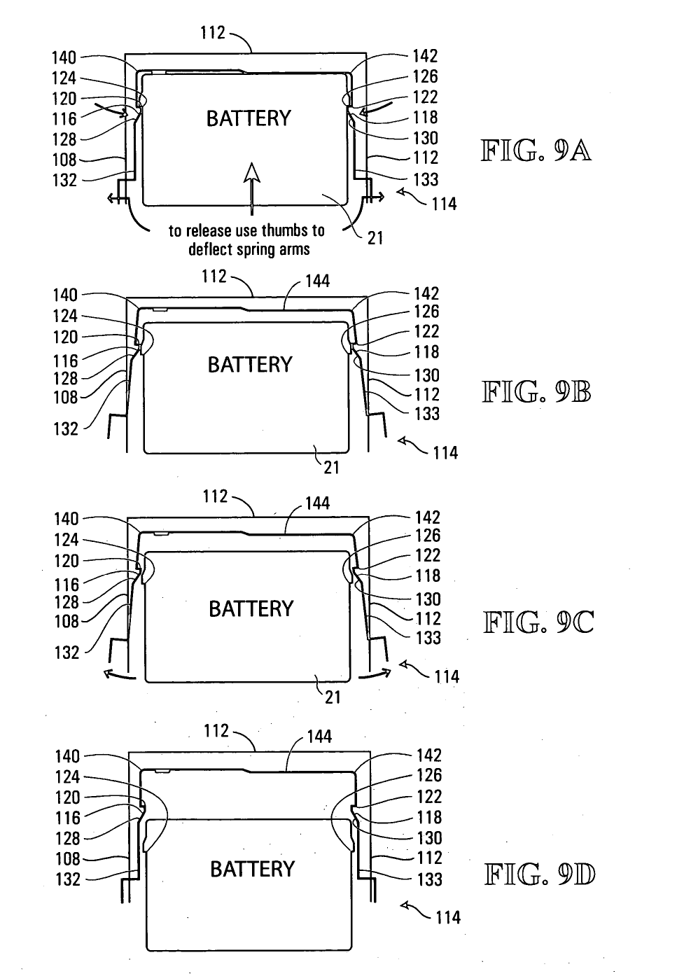

An embodiment of a battery housing and mounting system for a radio transmitter unit will now be described with reference to FIGS. 2 and 9A to 9D. The battery housing comprises a support base or platform 106 for supporting a battery 21, opposed side walls 108, 110 and a back plate or panel 112.

A latching mechanism generally shown at 114 is provided to releasably fasten a battery in the housing. The latching mechanism 114 comprises first and second latches 116, 118 defining a latching surface 120, 122 which engage a protrusion 124, 126 (or lug) provided each side of the battery 21. Each latch 116, 118 further comprises a guide portion 128, 130 which engages the leading edge of the battery protrusions as the battery is inserted into the housing for urging the latching surfaces away from the sides of the battery, as shown in FIG. 9C, for example.

Each latch is provided on an arm 132, 133 which is capable of deflecting about a region 140, 142 near the back of the battery housing and beyond the engagement surfaces of the latch 116, 118. For example, the arms may comprise a resilient material to form spring arms. The arms may be formed separately, or the arms may be formed of a one piece spring element as for example shown in FIGS. 12A to 12D, with a portion 144 of the latching mechanism extending between the arms and positioned near the rear of the battery housing. This portion of the latching system may comprise a resilient material and at least a portion thereof may engage with the battery when the battery is inserted into the housing to force the battery against the latching surfaces of the latch 116, 118 so that the battery is held firmly in place. Advantageously, the arms 132, 133 extend to a position adjacent the front of the battery housing and are accessible manually to allow the latching mechanism to be disengaged from the battery and the battery removed. Resilient means may be provided at the rear of the housing to engage the battery and move the battery automatically beyond a position at which the battery can be latched by the latching mechanism so that after moving the arms away from the battery, the battery is automatically pushed forward and released and remains in a released position without the need to maintain an external force on the arms, so that an operator's hands are free to withdraw the battery from the housing. The resilient means may be provided by the rear portion 144 of the latching mechanism, and/or by another element.

Modular Unit Coupling System

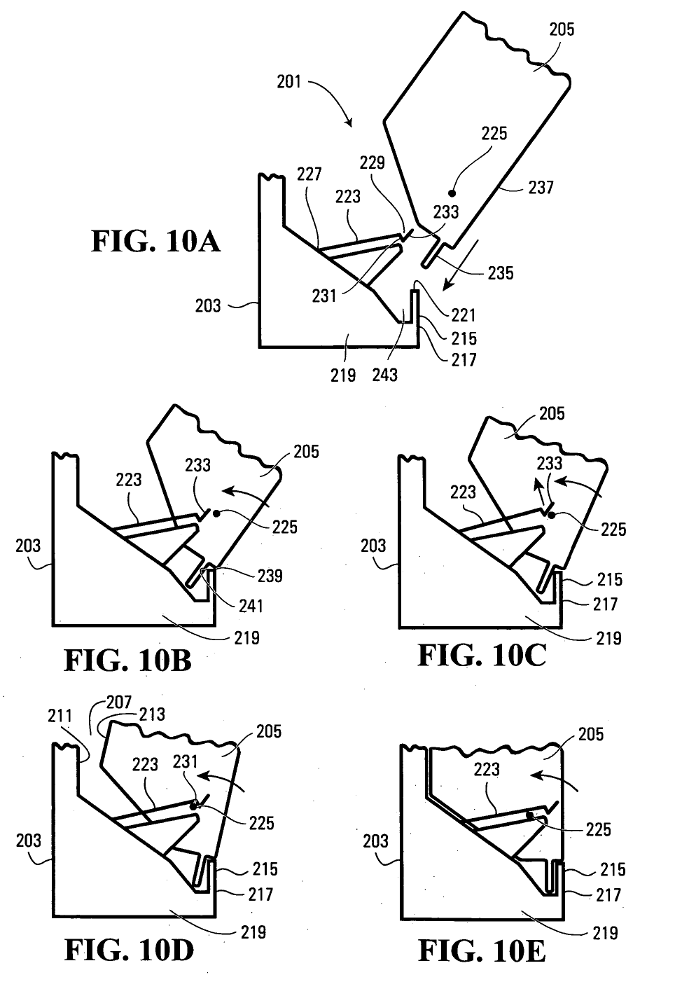

As described above, each rf module is detachable from the main unit, and a coupling mechanism is provided to releasably fasten each module to the main unit. An example of a coupling system for releasably interconnecting an rf power module to the main unit is shown in FIGS. 10A to 10E. Referring to FIGS. 1, 2 and 10A to 10E, a wireless transmitter 201 comprises a main and auxiliary unit (e.g. rf module) 203, 205 to be releasably connected together. The main and auxiliary units each carry elements of a coupling arrangement which allows the auxiliary unit to be pivotally mounted to the main unit and retained in an open position, as shown in FIG. 10D. Advantageously, in this position, the auxiliary unit is supported by the main unit and at the same time a gap 207 is provided between the units to permit access to their opposed faces 211, 213. This may be particularly beneficial to enable electrical connections 214 (FIG. 2) to be made between the main and auxiliary units without needing to manually support the auxiliary unit while the connections are being made or broken. The coupling also allows the auxiliary unit to be swung into a closed position and locked to the main unit, as shown in FIGS. 1 and 10E.

The main unit 203 has a pivotal mounting 215 which in this embodiment is provided by an upstanding wall 217 extending from a base portion 219 and whose upper edge 221 provides a support surface for pivotally supporting the auxiliary unit 205, as for example shown in FIGS. 10B to 10E. The coupling further comprises limiting means for limiting pivotal movement of the auxiliary unit away from the main unit and for maintaining the auxiliary unit in a predetermined position on the pivotal mounting when the auxiliary unit is swung away from the main unit, as shown in FIG. 11D. In this embodiment, the limiting means comprises first and second members 223, 225 forming a latch for releasably latching the auxiliary unit to the main unit. In the example shown in FIGS. 10A to 10E, the first member 223 comprises a spring and the second member comprises a pin. The spring 223 is an elongate leaf spring having opposed proximal and distal ends 227, 229, in which the proximal end 227 is mounted to the main unit 203, and the distal or free end 229 is capable of deflecting upwardly.

A latching surface 231 or detent is provided near the free end 229 for latching over the pin 225 as shown in FIGS. 10C and 10D. In this embodiment, the latching surface is provided by a kink or bend in the leaf spring, although in other embodiments, the latching surface may be provided by any other means. The latching surface 231 extends downwardly from the spring. A guide surface 233 is provided distally beyond the latching surface 231 for engaging the pin 225 and causing the spring to deflect upwardly after the auxiliary unit 205 is pivotally mounted on the main unit and the auxiliary unit is rotated towards the main unit and into the latched position, as shown in FIGS. 10C and 1D. It will be appreciated that in other embodiments, the pin could be mounted on the main unit and the spring on the auxiliary unit.

The auxiliary unit includes a protrusion 235 extending downwardly from a lower part thereof and which is inwardly offset from its outer edge 237 to provide pivotal bearing surfaces 239, 241 for supporting and locating the auxiliary unit on the pivotal mounting 215. The main unit 203 further comprises a pocket or recess 243 formed on the other side of the wall portion 217 for receiving the protrusion 235 when the main and auxiliary units are brought together. Advantageously, the protrusion 235 and locator pocket 243 assist in guiding the auxiliary units into position, and the protrusion also assists in locking the units into a locked position, as shown in FIG. 10E.

To attach the auxiliary unit to the main unit, the locating protrusion 235 extending from the auxiliary unit is first inserted into the locating pocket 243 in the main unit, as shown in FIG. 10A, until the auxiliary unit is pivotally supported on the main unit, as shown in FIG. 10B. The auxiliary unit 205 is then rotated towards the main unit about the pivotal mounting as shown in FIG. 10C and during rotation, the pin 225 engages the guide surface 233 of the spring and the spring deflects upwards as the pin moves underneath. On continued rotation, the spring returns towards its undeflected position and the pin engages the latching surface 231 to hold the auxiliary unit at a predetermined angular position relative to the main unit, as shown in FIG. 10D. The latching mechanism therefore holds the auxiliary unit in this position unless a force is used to deflect the spring. This allows the auxiliary unit to be retained in an open position until a force causes the spring to release it. On further rotation, the units are eventually closed together as shown in FIG. 10E, where the units may be locked by any suitable locking mechanism, for example a rotary lock 7, 9 (FIGS. 1 and 2). In order to detach the auxiliary unit from the main unit, the sequence is reversed. At the point where the pin engages the latching surface 231, the application of an additional outward force will cause the spring to deflect upwardly and the pin to disengage from the latching surface 231, releasing the auxiliary unit from the main unit and allowing the auxiliary unit to be removed therefrom, as shown in FIG. 10A.

As described above, the coupling system may be incorporated into a radio transmitter system, and used to connect modules of the system together. For example, the system may be incorporated into embodiments of the RF transmitter of FIGS. 1 to 6, or any other embodiment. The coupling system may be incorporated into any other apparatus for coupling two parts together.

Coupling System

A coupling system according to an embodiment of the present invention is shown in FIGS. 11A to 11C. The coupling system can be used to couple the transmitter unit to a backpack or other support structure, or may be used to couple any other article to a support or another element. The coupling system 301 comprises first and second coupling elements 303, 305 which inter-engage and lock together. The first coupling element 303 comprises a first part 307 having opposed first and second outer walls 309, 311 and a second part 313 extending outwardly from the first wall 309 and having a distal end 315. The second coupling element 305 comprises a receptacle 317 for receiving the second part 313 of the first coupling element 303, the receptacle being defined between first and second opposed surfaces 319, 321. The opposed surfaces 319, 321 are spaced apart by a distance which is sufficient to accommodate the length of the second part 313 of the first coupling element 303 defined between the second wall 311 of the first part and the distal end 315 of the second part. The second coupling element 305 further comprises a latch 323 and an aperture 325 between the first surface 319 of the receptacle and the latch 323 for permitting the second part 313 of the first coupling element 303 to pass therethrough into the receptacle 317 and engage with the latch 323 on relative rotation between the first and second coupling elements 303, 305 as shown in FIGS. 11A to 11C.

The width, W, of the aperture 325 is less than the length of the second part 313 of the first coupling element 303, and therefore the second part 313 of the first coupling element cannot be inserted into the receptacle with the walls 309, 311 of the first part 307 of the first coupling element 303 being generally aligned with the first and second surfaces 319, 321 of the receptacle, as shown in FIG. 11A. The second part 313 of the first coupling element includes a dimension there-across which allows the second part 313 to be inserted through the aperture into the receptacle when the coupling elements are rotated relative to one another, as shown in FIG. 1C. Once the distal end 315 of the second part 313 has passed through the aperture into the receptacle 317 as shown in FIG. 11B, the second coupling element can then be rotated in a direction such that the second wall 311 of the first part 307 and the first surface 319 of the receptacle are brought into alignment, as indicated by the arrow 327.

As shown in FIG. 11A, in this embodiment, the length of the second part of the first coupling element is substantially equal to the distance between the opposed walls 319, 321 so that in the locked position, opposite ends of the second part abut against the walls of the receptacle thereby substantially limiting or preventing lateral movement in the direction indicated by the arrow 329.

In this embodiment, the second coupling element 305 includes an abutment surface 331 at the entrance to the aperture 325 and which is effectively an extension of the first receptacle surface 319. In the locked position, the second surface 311 of the first part of the first coupling element and the abutment surface 331 engage one another, and these inter engaging surfaces limit lateral motion of the coupling elements relative to one another, again as indicated by the direction of arrow 329. Thus, in other embodiments, where the proximal end of the second part 313 does not engage the first surface 319 of the receptacle, lateral movement of the coupling elements relative to one another may still be limited by engagement between the abutment surface 331 and second surface 311 of the first part 307.

In this embodiment, the second part 313 has an engagement surface 333 for engaging the latch 323 and a generally opposed surface 335, a portion of which engages the surface 337 of the receptacle which is generally opposite the aperture 325 and/or latch 323, thereby limiting or preventing vertical movement between the coupling elements, in the direction indicated by the arrow 337, when the coupling elements are in the locked position, as shown in FIG. 11A. Advantageously, the surface 335 of the second part is curved adjacent the distal and proximal ends thereof to provide a smooth bearing or cam surface for engaging and supporting the various surfaces of the receptacle as the second coupling element is rotated from the unlocked to the locked position. Advantageously, the curved surface provides a smooth transition and rotation of the coupling elements between the locked and unlocked positions.

Although in the embodiments shown in FIGS. 11A to 1C, the surfaces of the receptacle are generally planar, in other embodiments, the surfaces may be curved in a similar manner to the curvature of the second part of the first coupling element.

FIGS. 12A and 12B show an example of a portable system in which the coupling system of FIGS. 11A to 11C may be incorporated. In one embodiment, the portable system comprises a wireless transmitter unit, for example, a transmitter unit according to any embodiment described herein. In other embodiments, the portable unit may comprise any other article. Referring to FIGS. 12A and 12B, a plurality of first coupling elements 403, 404 form a part of a bracket 451 for mounting to a back carrier frame 453 for supporting a portable unit 455. In this embodiment, the bracket includes a base portion 457, an upright portion 459 extending upwardly therefrom and a flange portion 461 extending downwardly from the top of the upright portion 459 and spaced therefrom to allow the bracket to be mounted over a lateral mounting plate 463 provided between frame members 465, 467. The portable unit 455 has an outer casing 469 and a base 471 in which the receptacles 417 of the second coupling element 405 are provided and which are located to register with the complementary first coupling elements 403, 404 provided on the mounting bracket 451.

One or more fasteners 473, 475 are attached to the carrier frame 453 above the mounting bracket 451 for fastening an upper portion 477 of the portable unit 455 to the frame after the first coupling elements have been inserted into the receptacles of the second coupling elements and the unit rotated from an angled position towards a vertical position, as indicated by the arrow 460. In this embodiment, the fasteners comprise first and second spaced apart straps with snap connectors 470, 472 which fasten around a handle 476 of the portable unit 455. However, in other embodiments, it will be appreciated that the upper portion of the portable unit may be secured to the carriage frame by any other suitable means.

One or more spacers 478 may be provided on the frame (and/or the portable unit) to provide a spacing between the frame and the portable unit. The spacers provide a surface against which the portable unit can be pressed by the fasteners 473, 475. One or more spacers may comprise a resilient material to allow some compression thereof, for example when the fasteners 473, 475 are tightened.

The carrier frame may include a pair of laterally spaced shoulder straps 481 and an optional waistband or belt 483. The carriage frame may optionally include one or more additional fasteners 485, 487 (e.g. straps or webs with connectors at each end) to facilitate mounting the frame on a horizontal bar or other mounting point as for example may be provided in a vehicle (e.g. roll bar). One or more additional fasteners 488, 489 (e.g. webs or straps) may be provided on the frame, and have connectors 490 which allow the additional fasteners to be connected to the upper fasteners 485, 487, thereby providing one or more enlarged fastening loops for securing the frame around a relatively large object for mounting the frame thereto.

A lateral fastener 491, comprising for example a web or strap and having complementary connectors 493, 495 may optionally be provided on the frame for securing the frame to a relatively large object, such as a telegraph pole, street lamp, or other object.

A carrying handle 494 may optionally be provided on the frame.

Advantageously, once the portable unit 455 has been secured to the frame, embodiments of the coupling system can prevent both vertical and lateral movement of the portable unit relative to the frame. It will be appreciated that a bracket 451 for supporting the coupling system can have any desired configuration, may be secured to the portable frame by any suitable means and may be manufactured as part of the frame, and, for example, either permanently attached thereto or integrally formed therewith.

Interface for Configuring a Wireless Transmitter

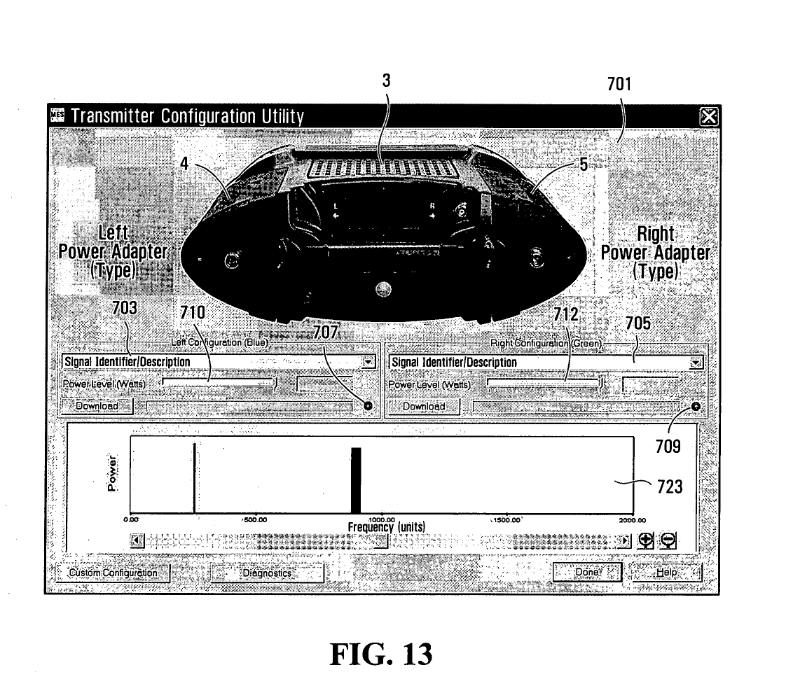

An example of an interface for configuring a wireless transmitter according to an embodiment of the present invention will now be described with reference to FIGS. 13 to 17. Different functions and operating modes of the wireless transmitter may be configured via a suitable interface, for example a graphical user interface carried on a suitable computer or processor such as a personal computer (PC) or laptop or other suitable platform which, in one embodiment may comprise a tough book man-machine interface (MMI). The wireless transmitter may include a suitable communications port, for example communication port 70 in FIG. 5, to allow communication signals to be transmitted from the interface to the wireless transmitter and so that the interface can be releasably connected to the wireless transmitter (e.g. via a cable).

Referring to FIG. 13, the interface comprises a screen 701 which may optionally display an image of the wireless transmitter. The wireless transmitter comprises a main unit 3 and first and second detachable units 4, 5. The wireless transmitter may include means for enabling the presence or absence of a detachable module to be detected and for the image of the wireless transmitter to be modified to indicate the absence and/or presence of each detachable module 4, 5. In this embodiment, the screen is adapted to display the present and/or future configuration of the left-side module 4 and/or that of the right-side module 5, and may be arranged to display the configurations on the same screen as shown in FIG. 13 or on different screens (e.g. windows). The display includes means for indicating if the shown configuration of a module is actually loaded on the unit and may comprise for example a light (e.g. LED) 707, 709 or other indicator. If the configuration is loaded, the LED (or other indicator) may display one colour such as green, otherwise, if the shown configuration is not loaded, the indicator may indicate another colour, for example red. The display 701 may provide a description 703, 705 of the mode of operation of the or each releasable module 4, 5 such as the signal transmission and/or jamming mode, for example, whether the carrier frequency is static (i.e. spot) or whether the carrier frequency is being swept, and may also display the power level 710, 712 of the wireless signal.

The display may optionally include a graphical display showing a plot of one transmission parameter as a function of another transmission parameter and in the example of FIG. 13, the graphical display is power versus frequency. The frequency and/or frequency range generated by each module 4, 5 may be displayed on the same graph as shown in FIG. 13, or on separate graphs.

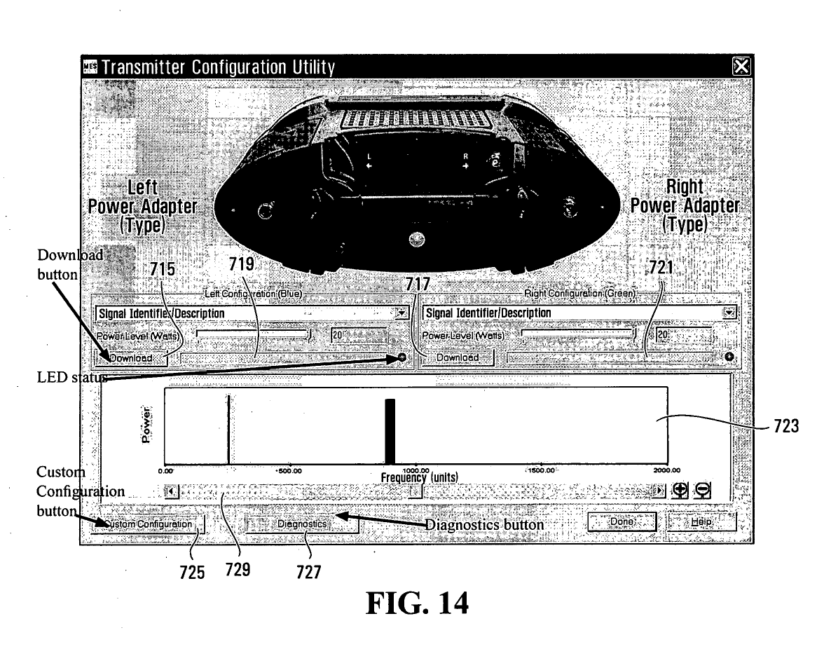

Referring to FIGS. 13 and 14, the screen may comprise a download button 715, 717 for downloading a selected configuration for the module 4, 5 and activation of the download button causes the selected configuration (software/instructions) to be loaded from the interface into a suitable memory in the transmitter, for example, in the main unit 3, for each respective side 4, 5. For example, the memory 84 shown in FIG. 8 may be used for this purpose, or another memory could be used. The progress of the download may be represented by a progress bar 719, 721 and/or by the download indicator turning from one colour to another colour, for example, red to green to indicate a successful download. Once the download is completed, the operating mode for the or each module 4, 5 may be shown on the spectral display 723.

In embodiments of the interface, the interface may allow a user to create one or more custom configurations which may be stored and available for download, by representation in a menu (e.g. dropdown box) for one or each module 4, 5. For this purpose, the screen may include one or more custom configuration buttons 725. The screen may include one or more diagnostic buttons 727 to allow a user to run one or more system diagnostic tests and/or use the interface to turn the unit on or off.

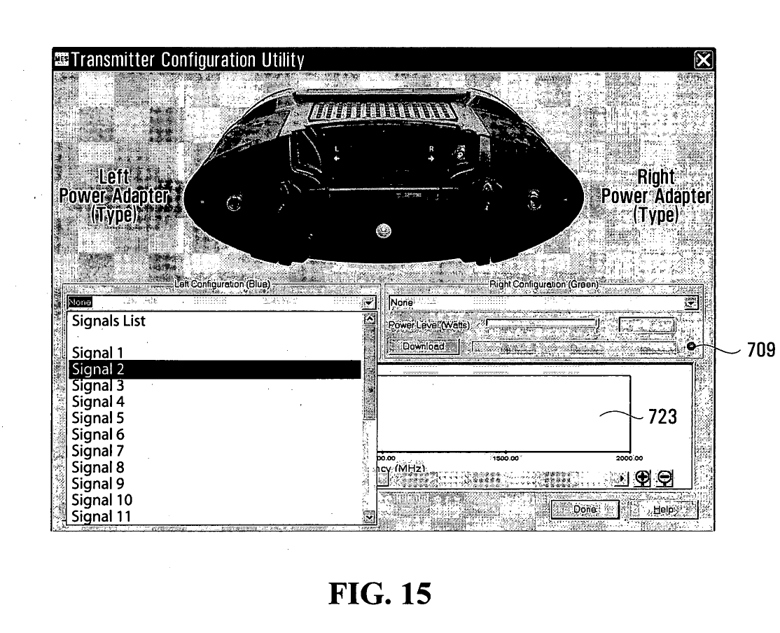

A control interface such as a slider bar 729 may be provided to allow the spectral display to be manipulated. An interface such as zoom in and zoom out buttons 731, 733 may be provided for expanding and contracting the displayed frequency and/or frequency band or other details of the spectral display 723. Referring to FIG. 15, control buttons 735, 737 may be provided to activate and deactivate a configuration menu 739, 741 for each module 4, 5. By selecting the dropdown menu, the user can select and download a number of pre-configured RF transmission settings from the GU interface. Once a pre-configured setting has been selected, the download may be activated and an indication may be provided once the download has been completed, for example by means of the progress bar and/or light 707, 709, as described above. A description of the new configuration may be shown in the spectral display window 703, 705.

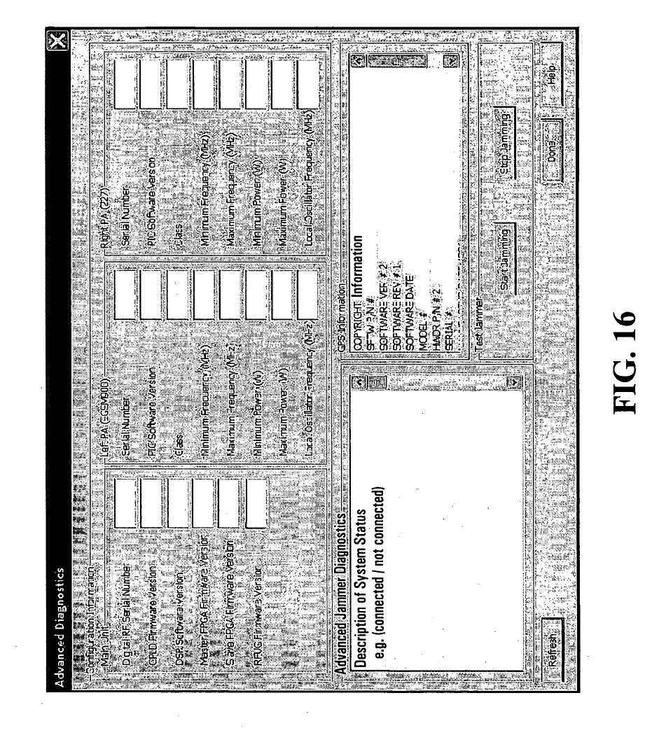

FIG. 16 illustrates an example of a diagnostic display which may be activated by a diagnostics button, for example, button 727 shown in FIG. 14. In embodiments of the present invention, the diagnostics may include any one or more of the types of parameters displayed in FIG. 16 and provide any one or more of the specific types of information disclosed in FIG. 16. For example, the display may indicate any one or more of the characteristics and/or parameters of one or more modular units 4, 5 connected thereto and/or a modular unit may include means for providing this information automatically to the interface.

The diagnostic display may display any one or more characteristics of the main unit and/or a modular unit 4, 5.

Embodiments of the interface may comprise any one or more of the following characteristics.

Base Configuration

This may allow a user to select a current configuration as a starting point for creating a new customer configuration.

Jamming Mode

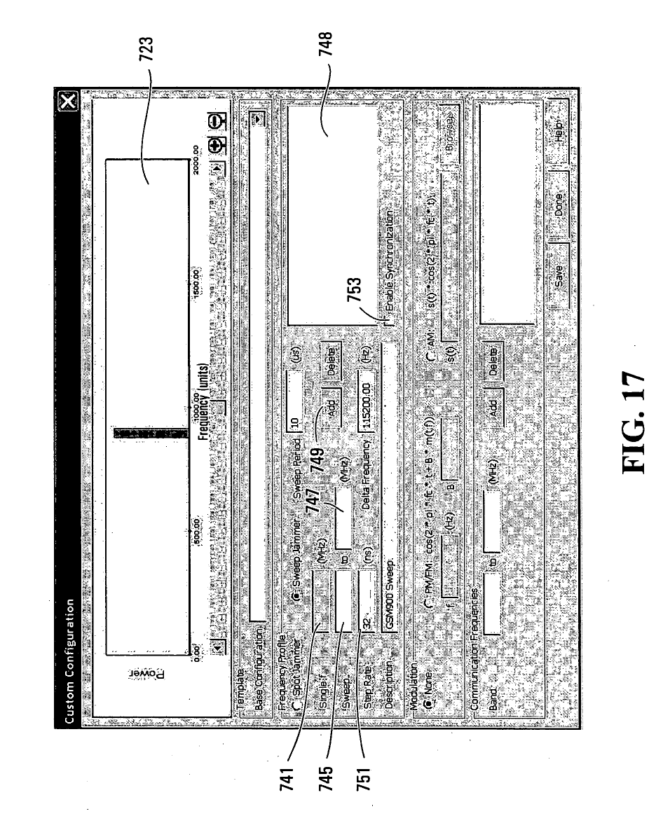

This allows a user to select a spot or swept inhibition/jamming mode. When spot jamming is selected, the desired frequency can be entered in a single f (frequency) box, for example box 741 shown in FIG. 17. If sweep jam is selected, a user may enter a frequency range within which the frequency is to be swept and may for example enter the sweep start and stop frequencies. Conveniently, these parameters may be entered boxes 745, 747 in the display shown in FIG. 17.

Regardless of the jamming mode selected, the user may then press an add button to add the selected one or more frequencies to the operating mode by, for example, entering one or more frequencies in the list box 748 and this may involve activating an add button 749. Once added, a relative field may be cleared and the selected one or more frequencies added to the frequency list box and displayed on the spectral display.

Step Rate

A step rate control, for example 751 in FIG. 17 may control how often the frequency is changed as the frequency is swept.

Delta Frequency

A control may be provided to control and/or set the incremented change, infrequency, e.g. the amount if the frequency increases or decreases each time the frequency is changed.

The step rate and delta frequency fields may be related. The interface may calculate the size of the change in frequency or delta frequency required to complete a sweep. The step rate may be expressed as a minimum increment and the interface may adjust the jump size or delta frequency accordingly.

Power Control

Power of the wireless transmission signal may be set and/or controlled from the interface by means of a power control button for example a power slider bar or other device which may be displayed on the interface screen. This may provide an indication of the actual power output in watts, or an indication proportional thereto.

A description of the custom configuration may be stored with the configuration and may be shown on the visual display, for example, in a dropdown menu box on a screen, for example the main screen or other screen, and may be added for example, to the configuration menu of each module 4, 5.

A controller for controlling and/or configuring the use made of a received signal may be provided, and in one embodiment, the interface may be adapted to allow receipt of any one or more desired frequency or range of frequencies, for example a reference signal, such as a GPS signal. The reference signal may be used for synchronization of operation of the transmitter and/or used to measure the transmitter's global position. Synchronization may be activated by an enable synchronization button 753.

Modulation

The interface may include means for enabling a user to superimpose modulation onto the RF waveform, for example, either a spot (static) waveform and/or a swept RF waveform. The interface may provide one or more types of different modulations and may include any one or more of phase modulation, frequency modulation and amplitude modulation. Advantageously, amplitude modulation can be used to generate, for example, a comb or series of tones. Modulation allows multiple frequencies to be generated simultaneously over any preselected, predetermined or desired frequency band and each frequency may have any desired amplitude within that band. Advantageously, the predefined band of frequencies may all be swept simultaneously by sweeping the carrier frequency which they modulate. As shown in FIG. 17, the interface may also provide a mode in which no modulation of the carrier signal is required.

Browse

The interface may provide a browse mode in which a user is permitted to select one or more predetermined modulation configuration files.

Communication Frequencies

A communication frequency control may be provided on the interface, as shown in FIG. 17, to allow a user to add or delete communication channels to the generated jamming or inhibition signals. These channels may be shown conveniently on the spectral display 723. Advantageously, the communication channel(s) may be displayed in a manner which enables a user to differentiate it or them from transmission frequencies, for example by displaying the communication channels in a different colour or providing some other indication.

In embodiments of the present invention, any one or more features of the transmitter may be configurable. This may include any one or more of an indicator which indicates a mode of operation of the transmitter or whether the transmitter is on or off, and the indicator may be configured to change the type of visual indication provided or to activate or deactivate the visual indicator. The transmitter may include a configurable audio signal, for example an audio alarm or other audible indication of a mode of operation of the transmitter and the audio signal may be configurable, for example between active and deactivated states, or the audible signal may be configured in some other way, for example, by means of a change of frequency or tone or volume. The transmitter may be provided with an on/off switch to turn the transmitter on or off and operation of the on/off switch may be configurable. For example, activation of the on/off switch for different periods of time may condition the transmitter in different ways and the length of time an on/off switch has to be activated in order to switch the transmitter on or off may be configurable. In one embodiment, the on/off switch may be used to erase information such as software/algorithms/instructions or other functions stored in the transmitter, and this function may be reconfigurable.

Other features of the transmitter which may be configurable or reconfigurable are a display for displaying information about the transmitter and/or a GPS module or other module for receiving external signals and how the transmitter uses such signals.

In embodiments, a user interface may be provided to provide user inputs to the interface and/or transmitter, and may comprise any suitable device for receiving user inputs such as a mouse, keypad or other device.

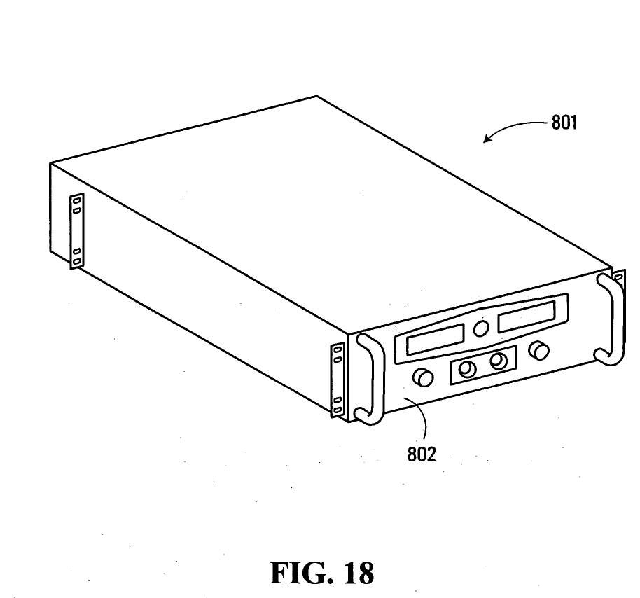

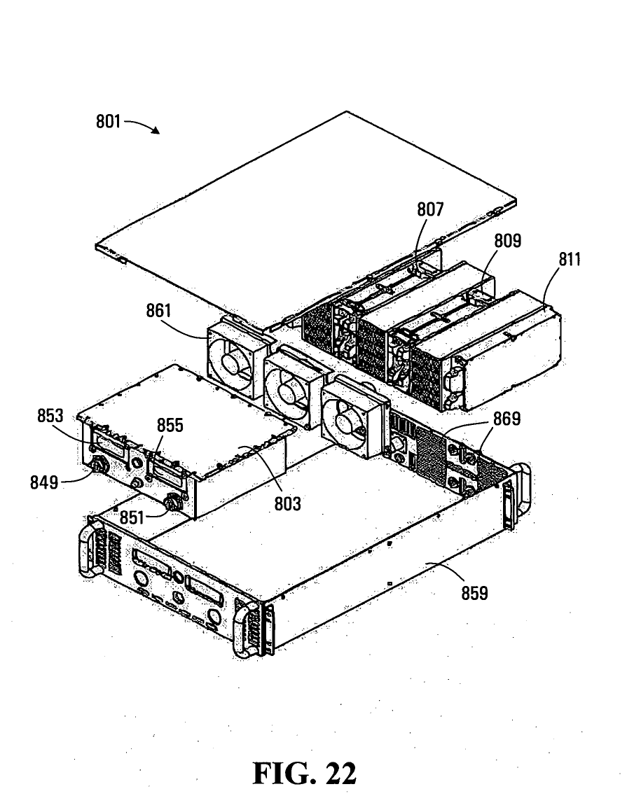

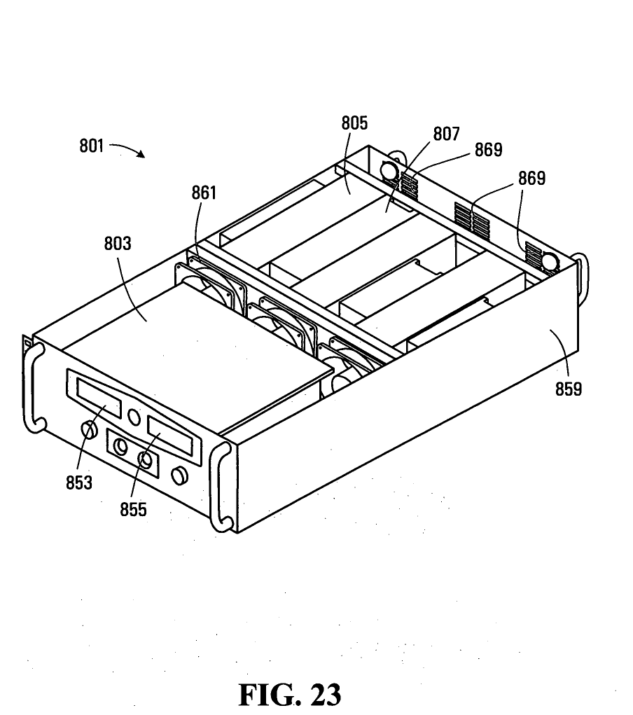

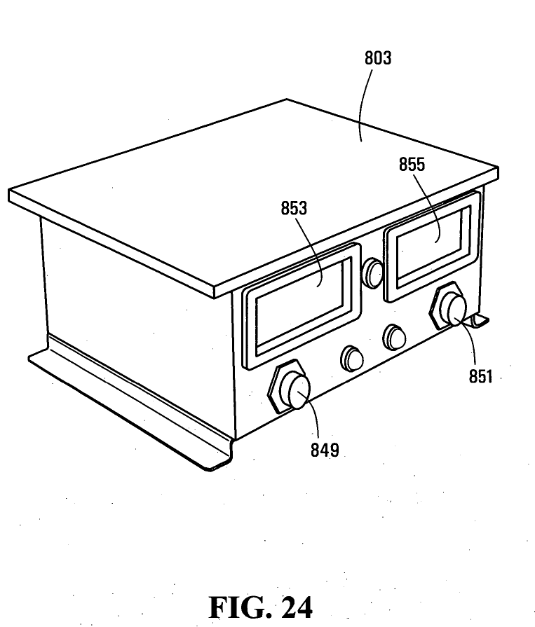

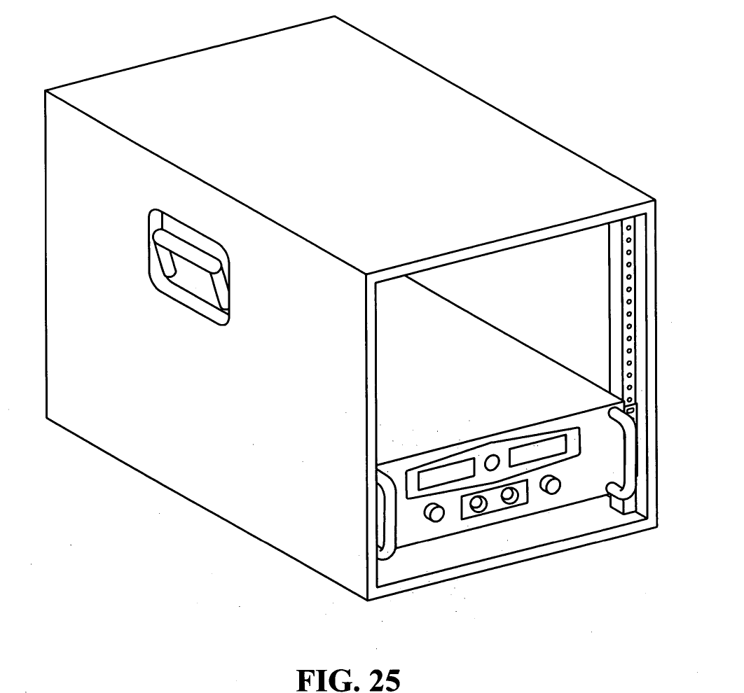

Embodiments of the radio transmitter system are capable of generating a plurality of RF channels simultaneously, each of which may be configured to provide a jamming signal for jamming external signals such as communication signals to disrupt or prevent proper reception of those signals. Advantageously, this system can be used to protect vehicles and an area around the vehicle from radio controlled explosive devices (RCIED). The radio transmitter may be used in other applications, including non-mobile applications. Another non-limiting example of a radio transmitter according to an embodiment of the present invention is described below with reference to FIGS. 18 to 27, and like parts are designated by the same reference numerals.

FIG. 18 shows an external perspective view of a radio transmitter 801 enclosed in a housing and which includes a front panel 802 having various elements and features described below.

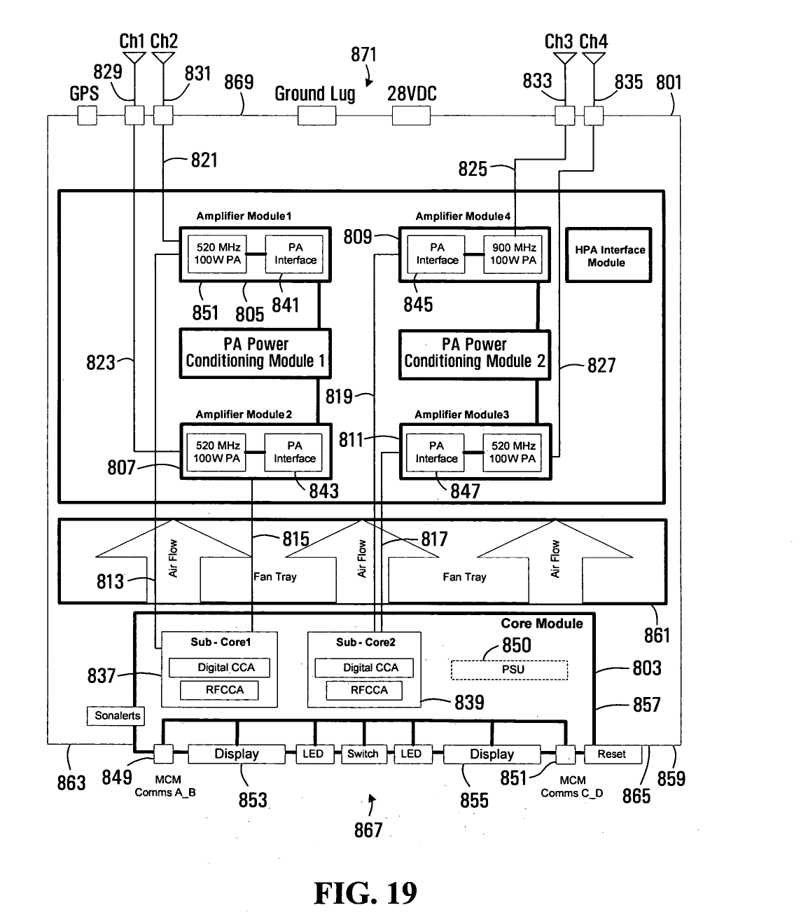

FIG. 19 shows a schematic diagram of an embodiment of a radio transmitter. The radio transmitter 801 comprises a signal generator 803 and a plurality of amplifier modules 805, 807, 809, 811. The signal generator 803 is capable of generating a plurality of carrier signals or channels simultaneously and has a plurality of channel outputs 813, 815, 817, 819 each connected to the signal input of a respective amplifier module 805, 807, 809, 811. Each amplifier module has an output 821, 823, 825, 827 for outputting the amplified signal to a respective antenna 829, 831, 833, 835. In this particular embodiment, each of the amplifiers is a power amplifier. Three amplifiers may have a similar frequency range, and a fourth amplifier 809 has a different frequency range. Each amplifier may be capable of generating a relatively high output power. In other embodiments, any one or more amplifiers may have any frequency range and maximum output power.

In this particular embodiment, the signal generator comprises two generator sub-cores 837, 839 each of which generates two channels for two power amplifiers and is responsible for controlling operation of two amplifiers. Each sub-core 837, 839 has an interface for communicating with each amplifier module under its control through a respective power amplifier interface 841, 843, 845, 847.

Each sub-core generates two channels and the frequency (i.e. carrier frequency) of each channel can be selected and varied, as required. In other embodiments, each sub-core may be adapted to generate any number of channels. In a particularly advantageous embodiment, the signal generator includes at least one waveform generator for generating a desired waveform to be carried by an RF channel. In one particular embodiment, the signal generator includes a waveform generator for generating a waveform for each channel. The radio transmitter comprises an interface for receiving user input signals for controlling and setting the frequency of each channel and also the waveform for each channel, if this latter feature is provided. The interface may include one or more switches or keys on the unit itself for receiving user commands and/or may include one or more communication ports for connection to and for receiving signals from a remote user interface unit such as a computer or handheld device such as a personal digital assistant (PDA), for example, an interface as described above with reference to FIGS. 13 to 17. In the embodiment shown in FIG. 19, the unit includes two communication ports 849, 851, one of which is associated with the first generator sub-core 837 and the second is associated with the second generator sub-core 839. The radio transmitter further includes one or more visual displays 853, 855 for displaying information to a user.

In this and other embodiments, a communication port may not be associated with any particular signal generator or sub core, and may be used to communicate with any sub core equally. For example, either port may be used to communicate with any sub core, through an inter-sub core communication bus, as necessary. In another embodiment, a single communication port may be provided for communication with all sub cores or signal generators.

A memory 850 (e.g. a program storage unit (PSU)) may be provided for storing programs or instruction code for controlling operation of the radio transmitter, and/or predetermined waveforms, and/or other information or data.

Components of the signal generator are housed in a protective housing 857 which may be sealed to prevent the ingress of moisture, and other environmental contaminants, e.g. particulate matter such as dust and sand. Electromagnetic shielding may also be provided to shield components of the signal generator 803 from electromagnetic noise and external signals.

The radio transmitter 801 comprises a housing 859 for enclosing the signal generator and amplifier modules.

The radio transmitter unit further comprises a cooling system for cooling the amplifiers, and in this embodiment is positioned between the signal generator unit 803 and the array of amplifier modules. The cooling system comprises one or more cooling fans for providing a flow of air directed through cooling ducts or channels 863, 865 positioned at or near the front of the unit 867 over the power amplifier modules and through an outlet port(s) 869 positioned at or near the rear 871 and/or rear sides of the unit. The power amplifier modules may include surface structure such as cooling fins to increase the surface area for heat transfer to the cooling air. Positioning the cooling system 861 between the signal generator module and the power amplifier modules assists in thermally isolating the signal generator from the amplifier modules. In some embodiments, the fans are environmentally sealed. This removes the need for filters and the servicing thereof, and significantly improves and extends operability of the system. Furthermore, the fan(s) are arranged upstream of the amplifiers in relation to the air flow, so that the air flowing passed the fans is still cool. This enhances the reliability of the fan(s) over an arrangement in which the fan(s) are positioned downstream of the amplifiers, and which would then be subjected to heat transferred into the air flow from the amplifiers.

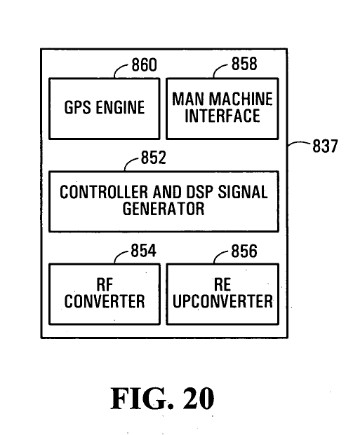

FIG. 20 shows a schematic diagram of a signal generator sub-core according to an embodiment of the present invention. The sub-core 837 comprises a controller and DSP (digital signal processor) signal generator 852, an RF up-converter 854, 856 for each channel, a user interface 858 for controlling and programming functions of the sub-core. An optional GPS (global positioning system) engine or other reference signal received device 860 may be provided for receiving GPS or other reference signal(s) to coordinate operations of the unit with other units, for example, or for another purpose.

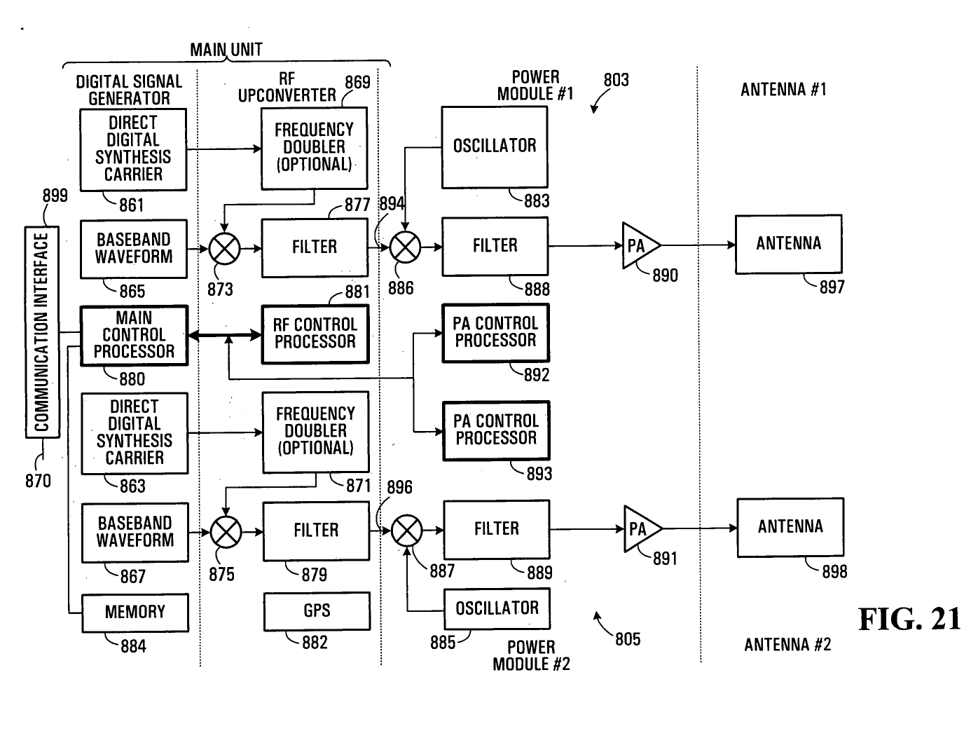

FIG. 21 shows an example of a signal generator sub-core in more detail, and which is similar to the unit shown in FIG. 8. For each RF channel, the unit comprises a direct digital synthesis carrier generator 861, 863, an optional baseband waveform generator 865, 867, an optional frequency doubler (or multiplier) 869, 871 and a filter 877, 879. The unit further comprises a main control processor 880 and an RF control processor 881. The unit may further comprise a reference signal receiver 882 for receiving a reference signal, for example a GPS (global positioning system), as indicated above.

The unit may comprise an optional up-converter stage for up-converting the carrier frequency of the channel. The up-converter stage may comprise a local oscillator (e.g. frequency synthesizer 883, 885), a mixer 886, 887 and a filter 888; 889. One or more amplifiers may include an interface 841, 843 (as shown in FIG. 19), and each interface may include a control processor 892, 893 (FIG. 20) for controlling functions of the power amplifier and communicating with the main control processor 880 and/or an option RF control processor 881.

Each carrier generator is operable to generate a carrier signal having a desired frequency which is optionally passed to a frequency doubler 869, 871 to modify, i.e. increase the carrier frequency before it is passed to the mixer 873, 875. The carrier frequency signal may optionally be modulated by a signal generated by the baseband waveform generator 865, 867, and the signal from the mixer 873, 875 is passed through a filter 877, 882 for removing unwanted frequencies optionally generated by the mixer 873, 875 before the signal is output to the power amplifier (via the optional up-converter stage, if present). The carrier frequency signal 894, 896 generated by the unit is passed to the mixer 886, 887 of the optional up-converter stage for up-conversion by mixing with a signal generated by the local oscillator 883, 885. This signal is then passed from the mixer 886, 887 to the filter 888, 889 to remove unwanted frequencies (mixing products), and the filtered signal is passed to the input of a respective power amplifier 890, 891, where it is amplified and then passed to an antenna 897, 898 for wireless transmission.

In one example, the signal generator may be capable of (digitally) generating carriers of up to 700 MHz or more, e.g. from 20 MHz to 700 MHz. The carriers can be digitally modulated with arbitrary phase and/or frequency modulation. Either in parallel, or at different times, a complex baseband signal can be generated that can be modulated onto the digital carrier by the RF up-converter.

In one implementation, an external communication device such as a PC which may run a proprietary graphical user interface (GUI) (e.g. the GUI described above with reference to any one or more of FIGS. 13 to 17) is used to define a waveform for transmission and generates the configuration files required by the system. These can be downloaded into the wireless transmitter, for example into on-board non-volatile memory.

In one implementation, the main control processor communicates with the RF up-converter and power amplifier control processors to configure them to generate the desired waveform. The radio transmitter may include means for alerting a user if it is established that the power amplifier is not compatible with the desired waveform. If necessary, the waveform definition file can be erased from the non-volatile memory when the system is powered down by holding the on/off switch for an extended period of time.

In some embodiments, it is possible to configure the unit to inter-operate with other systems by preventing unwanted transmissions outside the intended suppression bands. The timing with which the waveforms are generated can be precisely synchronized with sub-microsecond accuracy to a signal derived from the reference signal receiver, e.g. a global positioning system (GPS). The main control processor may be adapted to control all interface elements of the system, and may also perform system tests and monitoring. If the system enters a state where its operation is compromised, the controller may initiate one or more alarms, for example an escalating series of audio and visual alarms. The status of the system may be reported by the main processor on a visual display.

The function of hardware not directly associated with the signal generating function (i.e., any one or more of an on/off switch, visual display, piezo buzzer, tri-colour LED, GPS engine) can also be customized by downloading custom embedded firmware into the unit. For example, a user may wish to disable the LED and/or piezo warning system in specific operational roles or may require customized information to be displayed on the visual display.

The RF processor, in one embodiment, is a dual channel system which conditions the digital carrier and baseband signals generated by the digital signal processor. It may extend the frequency operation capability of the unit to 700 MHz or more and can directly modulate the digital carrier with the appropriate baseband signal to generate an intermediate or final waveform. The RF processor may also house a synthesizer which generates a clock signal (e.g. 1 GHz) that is used to clock the direct digital synthesis engines on the DSP signal generator.

The second generator sub-core may be similar to that just described or may be different therefrom by omitting or changing any one or more of the optional or other features.

Each generator sub-core is capable of generating carrier signals of different frequencies simultaneously. In this particular embodiment, the signal generator is capable of generating four carrier channels simultaneously and the frequency of each channel can be selected independently of the other channels. In one mode of operation, each channel may be set at a different frequency to effectively cover a wide spectral range, for instance. In another mode, two or more channels may be set at the same frequency, or overlapping frequency bands, to increase the power and possibly the effectiveness of the wireless signal (for example, by increasing the range of the signal or providing or enhancing some other characteristic or parameter of the signal). The signal on one or more channels may comprise a single or narrow band signal, for example, a simple sinusoidal wave.

Advantageously, the generating unit may include a baseband waveform generator and mixer for modulating the carrier frequency to provide a band of frequencies for simultaneous wireless transmission. Modulating the carrier frequency allows a number of different frequencies to be generated and transmitted simultaneously, which may significantly broaden the frequency of a jamming signal in an efficient manner.

In one implementation, the modulated carrier signal may be swept, for example, between first and second frequencies, and at any desired repetition rate (or swept only once). Additionally sweeping the modulated carrier signal over a range of frequencies can further increase the range of jamming signals that can be transmitted by the device in a short period of time.

As indicated above, in any embodiment, the carrier frequency(ies) transmitted by one module may be different to at least one, some or all carrier frequencies transmitted by another module, which significantly increases the versatility of the transmitter.

Referring to FIGS. 19 and 21, an amplifier module comprises a power amplifier and a control interface 841, 843, 845, 847 which communicates with the main control processor of a sub-core and implements a control data path to enable the core to control operation of the power amplifier. The core and power amplifier interface may be adapted to control any parameter of the power amplifier, as required, such as amplifier gain and/or attenuation. Functions of the power amplifier may also be monitored through the control interface and an alarm may be provided to signal improper operation or failure of a power amplifier or component thereof.

An RF interface 813, 815, 817, 819 is provided to carry the signal (e.g. jamming signal) to the power amplifier. In one embodiment, the power amplifier of at least one module can be adapted to amplify signals received from the core up to any required power levels, and over any desired frequency range. In the embodiment shown in FIG. 19, the transmitter unit comprises three amplifier modules, modules 801, 802 and 803 comprising power amplifiers with the same maximum power and frequency range.

In the embodiment of FIG. 19, one of the amplifier modules has a different frequency range from that of the other modules. In other embodiments, the power amplifier may operate in any other frequency band and at any other power levels. In some embodiments, the maximum frequency of the carrier signal that can be generated by the core module is less than the required signal frequency for wireless transmission. For example, the maximum frequency generated by the core module may be of the order of 500 MHz. In this case, an up-converter may be provided to up-convert the frequency of the signal generated by the core module, and in one embodiment, the additional up-converter is provided by a power amplifier interface module 850 shown in FIG. 19. In this embodiment, the up-converter up-converts the signal received from the core module to a signal having a higher frequency. The power amplifier receives RF signals from the power amplifier interface module and amplifies the signals to any required level. As will be appreciated, any other frequencies and signal power can be implemented and utilized. The power level for each channel can be varied independently of the other channels, and may be set to the same or a different level than another channel.

In some embodiments, a power conditioner is provided to condition the power supplied to each amplifier module. A separate power supply conditioning module may be provided for each amplifier module, or a power supply conditioning module may be shared between one or more amplifier modules. The power conditioning module ensures that a clean supply is presented to each power amplifier. The provision of power conditioning modules is particularly advantageous where the radio transmitter receives its power from the power supply of a vehicle. In one embodiment, the power supply conditioning module includes a high efficiency DC to DC switching converter which ensures that a clean DC supply of, for example, 28 volts, is provided to each power amplifier.

Physical Mounting

The radio transmitter unit can be installed in a vehicle, and an example of a mounting system is shown in FIG. 25. In this arrangement, the housing is installed in a shock mounted rack/transit case which is mounted within a vehicle. The case can be adapted to provide shock and vibration damping, and also sand and dust and electromagnetic impulse (EMI) protection, when the case is fully closed. The transmitter unit may be mounted horizontally as shown in FIG. 25, or mounted vertically, or on a separate shock mount plate.

Software Configurable Radio Transmitter Unit

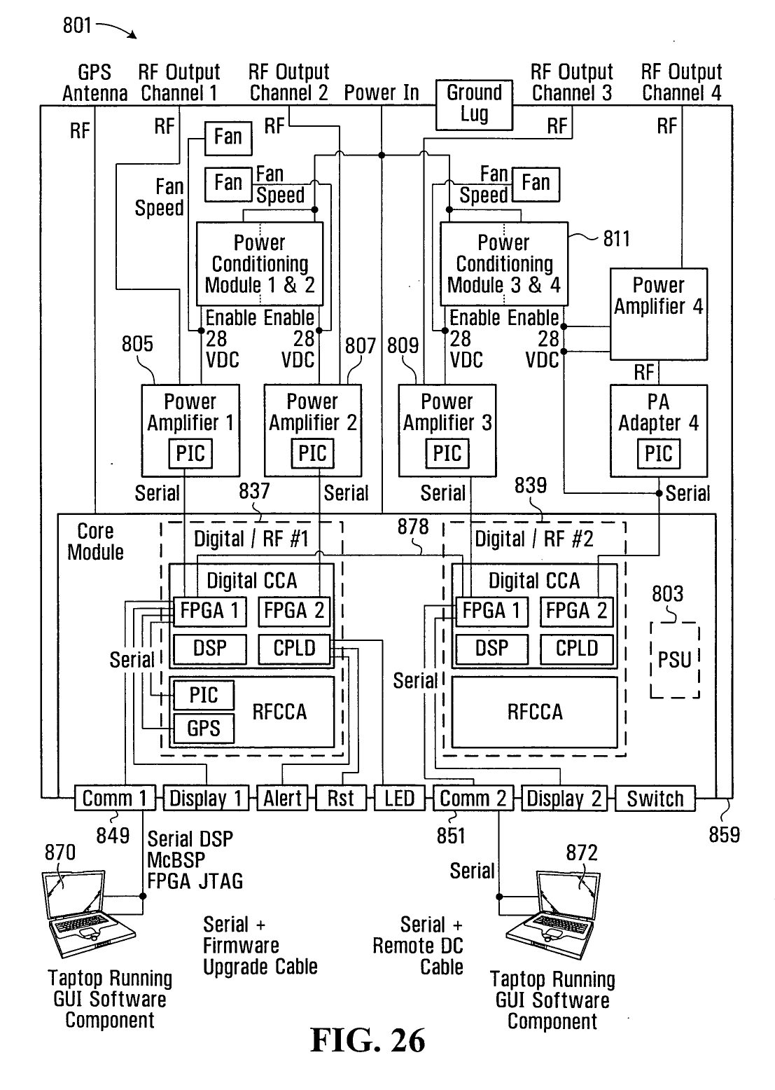

FIG. 26 shows a diagram of an embodiment of a transmitter unit, illustrating connections between various components of the unit. Each generator sub-core comprises first and second FPGAs (field programmable gate arrays), a DSP (digital signal processor), a CPLD (complex programmable logic device) and an RF CCA (Circuit Card Assembly). A respective FPGA is connected to communicate with the interface processor of a respective power amplifier module. Each power amplifier module has an associated power conditioning module for supplying electrical power to the power amplifier module, and one or more power conditioning modules may also provide power to drive one or more cooling fans.

In one embodiment, each generator sub-core may be controlled independently of the other. Each sub-core may be provided with its own communication port 849, 851 to allow the sub-core to be programmed by a communication device such as a computer 870, 872, as shown in FIG. 26.

In other embodiments, one sub-core may be adapted to control one or more functions of the unit as a whole. For example, one of the sub-cores may be designated as a primary controller and the other as a secondary controller. The primary controller may control functions such as an audible alarm, a visual indicator, such as an LED, and/or a reset button. The primary controller may be adapted to relay remote control commands to the secondary controller through a communication link 878. The commands may include turning on/off the radio transmitter, and signals adjusting the operating mode. The primary controller may be adapted to relay status information from the secondary controller for use on the remote control (e.g. computer) and user interface. The information relayed from the secondary controller by the primary controller may include BIT (Built-in-Test) information and/or configuration information such as version and load names. The primary controller may be adapted to turn on the audible alarm and/or the visual indicator (e.g. LED) if the secondary controller experiences an error. The primary controller may be adapted to command the secondary controller to erase its flash memory if a reset button is held for a predetermined length of time, for example, 5 seconds, or any other predetermined time.

The primary controller may be adapted to recognize fan speed alarms and take action, as necessary. The primary controller may be adapted to forward error messages to an external communication device, e.g. a computer coupled to a communication port. The digital signal processor may be arranged to parse the error message and pass a code to the remote/user interface to enable the remote and/or interface to take the required action.

Each generator sub-core may receive and store one or more waveform configurations via its respective communication port. These waveforms may be stored in a memory, for example, a random access memory or a flash memory. In another embodiment, a single communication port may be provided to enable external communications to both sub-cores.

As indicated above, the external communication device for communicating with the radio transmitter may comprise any form of computer such as a laptop and/or a remote personal digital assistant (PDA).

Embodiments of the wireless transmitter may be configured to operate in a wide range of different operating modes. The particular operating mode for one or more channels may be selected and set through a user interface of an external communication device. For example, the wireless transmitter may be configured to perform various jamming modes. In one embodiment, the user can select a spot or swept inhibition/jamming mode. When spot jamming is selected, the desired frequency can be entered through a user interface. If sweep jam is selected, a user may enter a frequency range within which the frequency is swept, and may, for example, enter the sweep start and stop frequencies. A step rate control may be provided to control how often the frequency is changed as the frequency is swept. A control may be provided to control the amount by which the frequency increases each time the frequency is changed.

Power of the wireless transmission signal may be set and/or controlled from an interface. The interface may provide an indication of the actual power output, for example in Watts, or an indication proportional thereto.

An interface may include means for enabling a user to superimpose modulation onto the RF waveform, for example either a spot (static) waveform and/or a swept RF waveform. The interface may provide one or more types of different modulations and may include any one or more of phase modulation, frequency modulation and amplitude modulation. Advantageously, amplitude modulation can be used to generate a comb or series of tones, for example. Modulation allows multiple frequencies to be generated simultaneously over any pre-selected, predetermined or desired frequency band, and each frequency may have any desired amplitude within that band. Advantageously, the predefined band of frequencies may all be swept simultaneously by sweeping the carrier frequency which they modulate. The interface may also provide a mode in which no modulation of the carrier signal is required. The forgoing are just some non-limiting examples of operating modes which some embodiments of the wireless transmitter may provide and other embodiments may be implemented to provide any other required or desired operating modes.

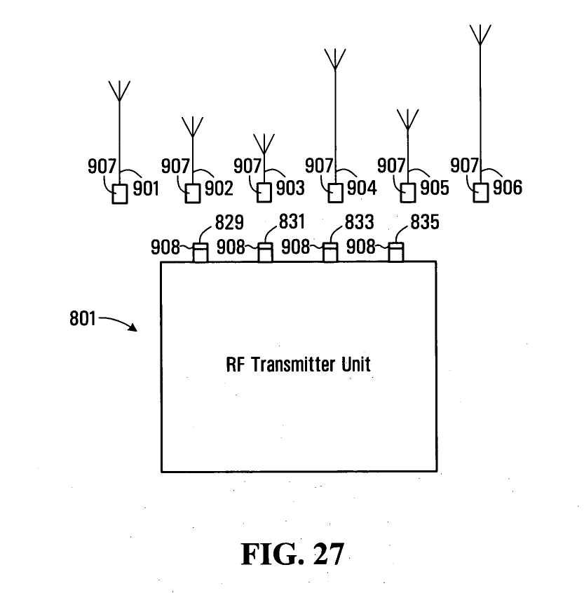

Embodiments of the invention may comprise a radio transmitter (for example as described herein, in combination with a set of antennae for use therewith, and an example is shown in FIG. 27. In this example, the radio transmitter is capable of generating four channels simultaneously and has four signal output ports 829, 831, 833, 835. A set of six antennae 101 to 106 is provided. Each antenna is selected to operate efficiently for a particular frequency or frequency band, each of which may be different from the others, or two or more may be the same. The antennae may be any suitable type, such as dipole antennae, or any other type. The provision of a set of antennae allows the antennae characteristics to be matched to the channel frequency used, for efficient operation and rf power transmission. The antennae and rf O/P ports can be provided with cooperating connector members 107, 108 to enable the antenna to be releasably connected to the ports. The connectors may comprise any suitable connectors and may include threaded connectors, bayonnette connectors or any other type of connector.

Other aspects and embodiments of the present invention comprise any one or more features disclosed in any of the applicant's co-pending U.S. Provisional Patent Application No. 60/664,702 filed on 24 Mar., 2005, under attorney docket no. 74698-119, U.S. Provisional Patent Application No. 60/665,833 filed on 29 Mar., 2005, under attorney docket no. 74698-129, and U.S. Provisional Patent Application No. 60/738,098 filed on 21 Nov., 2005, under attorney docket no. 74698-137, and all three co-pending applications are incorporated herein by reference in their entirety. In other aspects of the present invention, the wireless transmitter may have one or more feature(s) that is the same or similar to another wireless transmitter, for example a portable transmitter disclosed herein or in the co-pending applications. For example, any one or more features of the embodiments described with reference to FIGS. 1 to 17 may be combined with any one or more features of the embodiments described with reference to FIGS. 18 to 27. In one embodiment, the signal generators are adapted to be configured and/or controlled by the same or similar interface and/or computer program(s) as disclosed herein for the embodiment described with reference to FIGS. 1 to 17, for example, or any other embodiment.

Embodiments of the interface may include any one or more features of the interface disclosed herein, and any one or more features of the specific embodiments described herein may be omitted altogether or substituted by another feature, which may be an equivalent or variant thereof.

In embodiments of the transmitter system, the main unit or the rf power modules or any one or more features disclosed herein may be omitted altogether or substituted for another feature, which may be an equivalent or variant thereof.

Other embodiments of the present invention or aspects thereof comprise any combination of any two or more features disclosed herein.

Numerous modifications and changes to the embodiments described above will be apparent to those skilled in the art.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A radio transmitter for transmitting wireless signals comprising a main unit and first and second auxiliary units, means for releasably connecting said first auxiliary unit to the main unit, and means for releasably connecting the second auxiliary unit to at least one of said main unit and said first auxiliary unit, the main unit comprising signal generating means for generating a plurality of carrier signals simultaneously and means for delivering a carrier signal to each of said auxiliary units when connected thereto, each of said first and second auxiliary units comprising a signal conditioner for conditioning the carrier signal received from said main unit.

2. A transmitter as claimed in claim 1, wherein one or both of said signal conditioner(s) comprises one or both of an amplifier for amplifying the signal received from said main unit, and a signal converter.

3. A transmitter as claimed in claim 2, wherein said signal converter comprises an oscillator and mixer.

4. A transmitter as claimed in claim 3, wherein said oscillator comprises a frequency synthesizer capable of generating a range of different frequencies.

5. A transmitter as claimed in claim 1, wherein one or more of said auxiliary units comprises mounting means for mounting an antenna thereto.

6. A transmitter as claimed in claim 1, wherein said main unit further comprises one or both of (1) signal modulator means for modulating one or more of said carrier signals, and (2) frequency increasing means for increasing the frequency of at least one carrier signal.

7. A transmitter as claimed in claim 1, further comprising one or more configurable modules for controlling operation of said transmitter and an interface for receiving configuration data for configuring said one or more configurable modules based on said data.

8. A transmitter as claimed in claim 1, wherein one or more of said auxiliary unit(s) comprises means for transmitting information relating to said auxiliary unit(s) to the main unit.

9. A transmitter as claimed in claim 8, wherein said information transmitting means is adapted to transmit information in response to a signal received from said main unit.

10. A transmitter as claimed in claim 1, wherein said first and second auxiliary units each include an amplifier for amplifying a respective carrier signal, and wherein one amplifier is adapted to have a higher efficiency for amplifying signals having a predetermined frequency or frequency range than that of another amplifier at the same frequency or frequency range.

11. A transmitter as claimed in claim 1, further comprising a holder for holding a portable electrical power source for providing electrical power to one or more of said main unit and said plurality of auxiliary units.

12. A transmitter as claimed in claim 11, wherein said holder comprises a battery housing comprising a latch for releasably latching a battery in the housing, wherein the latch is positioned between a front and back of the housing, and further comprising control means for controlling the latch, and which is accessible from a position near the front of the housing.

13. A transmitter as claimed in claim 12, wherein said latch comprises an arm capable of deflecting away from and towards a side portion of the battery and includes an engaging surface for engaging a protrusion or recess on the side of the battery to retain said battery in said housing.

14. A transmitter as claimed in claim 13, further comprising means for moving said battery to a position beyond said engaging surface of said latch when said latch is released.

15. A transmitter as claimed in claim 1, further comprising a pivotal mounting for pivotally mounting an auxiliary unit to said main unit.

16. A transmitter as claimed in claim 15, further comprising retaining means for retaining said auxiliary unit at a predetermined pivotal position relative to said main unit when said auxiliary unit is swung away from said main unit about said pivotal mounting.

17. A transmitter as claimed in claim 16, wherein said retaining means includes a releasable mechanism for releasing said retaining means from at least one of said main unit and said auxiliary unit.

18. A transmitter as claimed in claim 1, further comprising a fastening mechanism for fastening the transmitter to a support.

19. A transmitter as claimed in claim 18, wherein said transmitter includes a casing and a receptacle positioned on the casing for receiving a locking member for locking the casing to a support.

20. A transmitter as claimed in claim 19, further comprising a first coupling element comprising a first part defining opposed first and second outer walls, and a second part extending outwardly from the first wall and having a distal end, and a length between the second wall and the distal end, and wherein the receptacle is adapted for receiving the second part, said receptacle being defined between opposed first and second surfaces which are spaced apart by a distance for accommodating the length of said second part, and latch means disposed between the opposed first and second surfaces of the receptacle, and an aperture between said latch means and the first surface of the receptacle for permitting the second part of the coupling element to pass therethrough into the receptacle and engage with said latching means on relative rotation between said coupling element and said receptacle.

21. A transmitter as claimed in claim 20, wherein said second part has a surface for abutting said latch means, and the surface generally opposite the latch engagement surface for engaging a surface of the receptacle to prevent relative linear movement between the coupling element and the receptacle when the second part is engaged with said latch means.

22. A transmitter as claimed in claim 20, wherein the length of the second part is substantially equal to the distance between the first and second surfaces of the receptacle.

23. A transmitter as claimed in claim 20, wherein the receptacle further comprises means defining an abutment surface for engaging the first wall of the first part of the coupling element when the second part engages the latch means.

24. A transmitter as claimed in claim 1, further comprising a portable casing for housing said transmitter.

25. A transmitter as claimed in claim 24, wherein said main unit comprises an outer casing, and each of said auxiliary units comprises an outer casing for fastening to at least one of the casing of said main unit and the casing of the other auxiliary unit.

26. A transmitter as claimed in claim 25, further comprising fastening means for fastening the casing of each auxiliary unit to the casing of said main unit.

27. A transmitter as claimed in claim 26, wherein the casing of each auxiliary unit is substantially flush with the casing of the main unit at the junction between the main unit and the auxiliary unit when the auxiliary unit is connected to the main unit.

28. A transmitter as claimed in claim 1, further comprising a controller for controlling operation of said transmitter.

29. A transmitter as claimed in claim 28, wherein said controller comprises a programmable module for receiving configuration data for configuring said controller to operate in accordance with said configuration data.

30. A transmitter as claimed in claim 29, further comprising storage means for storing a plurality of sets of configuration data, each defining a different configuration for said controller.

31. A transmitter as claimed in claim 30, wherein said storage means contains a plurality of sets of configuration data, each set defining a different waveform for wireless transmission by said transmitter.

32. A transmitter as claimed in claim 1, comprising a plurality of antennae, each arranged to receive and wirelessly transmit a respective one of said signals from a respective auxiliary unit.

33. A transmitter as claimed in claim 32, wherein the efficiency as a function of frequency of at least one antenna is different from that of at least one other antenna.

34. A radio transmitter comprising a first unit having signal generating means for generating one or more carrier signals and a second unit for receiving a carrier signal from the first unit and a connector for releasably mounting the second unit to the first unit and said second unit comprising a converter for changing the frequency of the carrier signal received from the first unit.

35. A radio transmitter as claimed in claim 34, wherein said second unit further comprises an amplifier for amplifying said carrier signal.

36. A radio transmitter as claimed in claim 34, wherein said signal generating means comprises means for generating a plurality of carrier signals simultaneously and wherein said second means is adapted to output at least one of said carrier signals, and said radio transmitter further comprises means for outputting at least one other carrier signal generated by said first unit.

37. A radio transmitter as claimed in claim 36, wherein said means for outputting comprises a third unit releasably mountable to at least one of said first unit and said second unit.

38. A radio transmitter as claimed in claim 34, further comprising a plurality of second units, each being releasably mountable to the at least one of first unit and another second unit, and each having at least one of a converter for changing the frequency of a signal received from the first unit and an amplifier for amplifying the carrier signal from the first unit.

39. A radio transmitter as claimed in claim 38, wherein the converter of at least one of said second units is adapted to convert a signal received from said first unit into a signal having a frequency which is different to the converted frequency of at least one other second unit.

40. A radio transmitter as claimed in claim 34, wherein at least one of said first and second units comprises an interface for enabling at least one function of a respective unit to be conditioned and/or configured.

41. A radio transmitter as claimed in claim 40, wherein at least one of said first and second units is configurable into any one or more of a plurality of different configurations and said interface enables one or more different configurations to be selected.

42. A radio transmitter as claimed in claim 40, wherein said transmitter further comprises any one or more of:
(a) a visual indicator for indicating information to an operator and wherein said visual indicator is reconfigurable, for example, to enable an operator to activate or deactivate said visual indicator or select a mode of operation thereof;
(b) an audio indicator for providing an audio signal and wherein said audio signal generator is reconfigurable, for example, to enable an operator to activate or deactivate said audio signal and/or to select a mode of operation thereof, for example volume or tone;
(c) a reconfigurable on/off switch which activates and deactivates said transmitter and which, for example, may be reconfigurable to activate and/or deactivate said transmitter only after said switch is activated for a predetermined length of time;
(d) a display for displaying information about said transmitter and which is reconfigurable by an operator, for example, to allow the display to be activated or deactivated or to configure information displayed thereby; and
(e) a receiver module capable of receiving wireless signals, for example, for controlling an operation of said transmitter, for example, the timing of transmission of wireless signals therefrom, and/or for measuring the global position of said transmitter and which allows the information obtained thereby and the use of the information to be configured and/or conditioned by an operator.

43. A module for a radio transmitter, comprising a port for receiving a signal to be transmitted and an amplifier for amplifying the signal, and means for coupling said signal to an antenna for wireless transmission.

44. A module of claim 43, further comprising means for releasably mounting said module to a unit for generating said signal.

45. A radio transmitter comprising:
a signal generator for generating simultaneously a plurality of signals; and
a plurality of amplifiers each arranged to receive and amplify a respective one of said signals for wireless transmission.

46. A radio transmitter as claimed in claim 45, further comprising a plurality of antennae, each arranged to receive and wirelessly transmit a respective one of said signals from a respective amplifier.

47. A radio transmitter as claimed in claim 46, wherein the efficiency as a function of frequency of at least one antenna is different from that of at least one other antenna.

48. A radio transmitter as claimed in claim 45, wherein said signal generator is adapted for generating said plurality of signals wherein at least one signal has a different frequency from at least one other signal.

49. A radio transmitter as claimed in claim 45, wherein said signal generator is adapted for permitting the frequency of one or more signals to be varied.

50. A radio transmitter as claimed in claim 45, wherein said signal generator is adapted for generating simultaneously three or more carrier signals or channels.

51. A radio transmitter as claimed in claim 50, wherein said signal generator is adapted to permit the frequency of at least three signals to be varied.

52. A radio transmitter as claimed in claim 45, wherein one or more of said amplifiers comprises a broadband amplifier.

53. A radio transmitter as claimed in claim 50, comprising three or more amplifiers.

54. A radio transmitter as claimed in claim 50, further comprising three or more antennae.

55. A radio transmitter as claimed in claim 45, further comprising a plurality of antennae for receiving and wirelessly transmitting a respective one of said signals from a respective amplifier, wherein the efficiency of one or more of said antennas varies as a function of frequency and wherein the antenna is efficient at the frequency of the signal to be wirelessly transmitted by said antenna.

56. A radio transmitter as claimed in claim 55, wherein the amplifier for connection to said at least one antenna comprises a broadband amplifier capable of amplifying signals of a predetermined range of frequencies and the antenna is efficient over a restricted range of frequencies within said predetermined range.

57. A radio transmitter as claimed in claim 55, wherein the amplifier for connection to said at least one antenna comprises an amplifier capable of amplifying signals over a predetermined range of frequencies and the antenna is efficient over a range of frequencies that is narrower than said predetermined range.

58. A radio transmitter as claimed in claim 45, further comprising an interface for conditioning said signal generator.

59. A radio transmitter as claimed in claim 45, wherein at least one of said signals generated by said signal generator comprises a jamming signal, a deterministic signal, a non-communication signal, a signal without information or data content or a signal having a single frequency or a signal which is modulated by a predetermined (e.g. synthesized) waveform.

60. A wireless transmitter comprising:
a signal generator for generating simultaneously a plurality of carrier signals each defining a channel;
amplifier means for amplifying the signal of each channel;
a plurality of ports, a respective port being associated with a respective channel and for outputting a respective amplified signal to a respective antenna for wireless transmission.

61. A wireless transmitter as claimed in claim 60, wherein the signal of one or more of channel(s) is deterministic.

62. A wireless transmitter as claimed in claim 61, wherein at least one deterministic signal comprises a single frequency or a plurality of predetermined frequencies.

63. A wireless transmitter as claimed in claim 60, further comprising one or more modulating signal generator(s) each for generating a modulating signal according to a predetermined waveform and arranged for modulating a carrier signal with said modulating signal.

64. A wireless transmitter as claimed in claim 60, further comprising data storage means for storing data defining one or more predetermined waveforms.

65. A wireless transmitter as claimed in claim 60, wherein said amplifier means includes a communications interface, and said transmitter comprises a communication module for communicating with said amplifier communication interface.

66. A wireless transmitter as claimed in claim 65, wherein said amplifier communication interface is adapted for transmitting to said communication module data indicative of at least one of information identifying said amplifier means, information relating to an operating capability of said amplifier means, information relating to the status of said amplifier means, and information relating to a fault or failure of said amplifier means.

67. An apparatus for displaying information about a radio transmitter, the transmitter being capable of generating and transmitting a plurality of wireless carrier frequency signals simultaneously, said apparatus comprising an interface for transmitting and/or receiving information to/from said transmitter, and a processor adapted for generating a visual representation of said information, and a graphical user interface for displaying said representation.

68. An apparatus of claim 67, wherein said interface is detachably connectable to said transmitter.

69. An apparatus of claim 67, wherein the processor is adapted to generate a display comprising a first part for displaying information about a first part of said transmitter and a second part for displaying information about a second part of said transmitter.

70. An apparatus as claimed in claim 67, wherein said graphical user interface comprises means for generating one or more graphical elements representing any one or more of:
(a) a mode of operation for said transmitter;
(b) a mode of operation for each of a plurality of different wireless transmission sections of said transmitter;
(c) a graphical representation of one or each carrier frequency transmitted by said transmitter;
(d) an indication of the status of one or more components of said transmitter;
(e) one or more identifiers and/or description of a configuration for said transmitter.
